(19) United States
(12) Patent Application Publication
(10) Pub. No.: US 2024/0361759 A1
(43) Pub. Date: Oct. 31, 2024

(54) METHODS AND SYSTEMS FOR DETERMINING SOURCES OF ANOMALIES IN MANUFACTURING PROCESSES

(71) Applicant: Gauss Labs Inc., Palo Alto, CA (US)

(72) Inventors: Byeongchan Lee, Seoul (KR); Jiae Kim, Seoul (KR); Sol Kwon, Seoul (KR); Joonho Seo, Seoul (KR); Yongho Jeon, Seoul (KR)

(21) Appl. No.: 18/612,081

(22) Filed: Mar. 21, 2024

Related U.S. Application Data
(60) Provisional application No. 63/498,209, filed on Apr. 25, 2023.

(51) Int. Cl. G05B 23/02; G05B 19/418

(52) U.S. Cl. CPC G05B 23/0235; G05B 19/41875; G05B 23/0272; G05B 2219/2602

(57) ABSTRACT

A method for determining a source of an anomaly in manufacturing processes can include obtaining measurement data of features of each product in a set of products, upon detection of the anomaly in a target product, identifying processing apparatuses among the processing apparatuses that have been traversed by the target product as candidate processing apparatuses, determining, for each candidate processing apparatus, a measurement data index indicating a degree of likelihood of the candidate processing apparatus being the source of the anomaly in the target product based on the measurement data obtained for a subset of products among the set of products that have traversed the candidate processing apparatus and a reference set of the measurement data obtained for the remaining products among the set of products, and outputting an indication of candidate processing apparatuses as the source of the anomaly in the target product based on the measurement data index.

### CROSS-REFERENCE TO RELATED APPLICATIONS

This application claims the benefit of U.S. Provisional Application No. 63/498,209, filed Apr. 25, 2023, which is incorporated by reference herein in its entirety.

### BACKGROUND

For producing products, a manufacturing system may perform a series of manufacturing processes, with each process being independently performed by multiple manufacturing apparatuses. In order to manage quality of products of such a manufacturing system, products may be inspected many times throughout the manufacturing processes. During the inspection, features or characteristics of the products being produced may be measured and compared against standard requirements. In case the measured features or characteristics deviate from the standard requirements by more than a predetermined threshold, the corresponding product may be determined to have an anomaly.

In a semiconductor manufacturing system, for example, a statistical process control (SPC) method has been used to detect an anomaly in semiconductor substrates during semiconductor processing. In such a method, when an anomaly is detected, an alarm is generated and the manufacturing process may be suspended until a cause of the anomaly is identified and corrected by engineers. However, since the cause of the anomaly is generally identified and corrected manually by the engineers, it has been time consuming and inefficient for engineers to identify the cause or source of the anomaly and resume the manufacturing processes, particularly in a manufacturing system involving complex processes and processing apparatuses.

### SUMMARY

According to an aspect of the present disclosure, there is provided a method for determining a source of an anomaly in a manufacturing process, comprising: (a) receiving sensor data of one or more process parameters associated with processing apparatuses for carrying out the manufacturing process: (b) receiving measurement data of one or more predetermined features associated with products of the manufacturing process; and (c) determining, based at least on the one or more process parameters and/or the one or more predetermined features, an anomaly index indicative of a likelihood of a candidate processing apparatus being the source of the anomaly.

In some embodiments, the manufacturing process comprises one or more manufacturing processes sequentially performed by one or more sets of processing apparatuses, respectively, one manufacturing process being performed by one set of processing apparatuses independently.

In some embodiments, the sensor data is detected by sensors of each of the processing apparatuses that have performed corresponding manufacturing processes on a plurality of products.

In some embodiments, the measurement data comprises one or more predetermined features of each of the products after the one or more manufacturing processes have been performed on each of the products.

In some embodiments, the method further comprises between (b) and (c), upon detection of the anomaly in a target product among the products based on the measurement data, identifying one or more processing apparatuses among the processing apparatuses that have been traversed by the target product as candidate processing apparatuses.

In some embodiments, the method further comprises between (b) and (c), determining, for each candidate processing apparatus, at least one first index indicating at least one first degree of likelihood of the candidate processing apparatus being the source of the anomaly in the target product based on the measurement data obtained for a subset of one or more products among a set of products that have traversed the candidate processing apparatus and a first reference set of the measurement data obtained for the remaining products among the set of products.

In some embodiments, the method further comprises between (b) and (c), determining, for each candidate processing apparatus, at least one second index indicating at least one second degree of likelihood of the candidate processing apparatus being the source of the anomaly in a target product based on the sensor data for the candidate processing apparatus obtained from performing the corresponding manufacturing process on the target product and a second reference set of the sensor data for the candidate processing apparatus obtained from performing the corresponding manufacturing process on one or more products among the plurality of products that have been processed before the target product by the candidate processing apparatus.

In some embodiments, the method further comprises after (c), outputting an indication of one or more candidate processing apparatuses as the source of the anomaly in the target product based at least on the anomaly index, wherein the anomaly index comprises the at least one first index and/or the at least one second index.

In some embodiments, determining the at least one first index indicating the at least one first degree of likelihood comprises comparing the measurement data obtained for the subset of one or more products among the set of products that have traversed the candidate processing apparatus and the first reference set of the measurement data obtained for the remaining products among the set of products, and wherein determining the at least one second index indicating the at least one second degree of likelihood comprises comparing the sensor data for the candidate processing apparatus obtained from performing the corresponding manufacturing process on the target product and the second reference set of the sensor data.

In some embodiments, the second reference set of the sensor data includes the process parameters of each of the products other than the target product on which the candidate processing apparatus has performed the corresponding manufacturing process.

In some embodiments, the manufacturing process comprises one or more semiconductor manufacturing processes, wherein the processing apparatuses comprise one or more processing chambers, and wherein the products comprise one or more semiconductor wafers.

In some embodiments, the one or more process parameters include at least one of a temperature, a pressure, power, or a flow rate, and wherein the one or more predetermined features include at least one of a depth, a thickness, length, or a radius of a product.

In some embodiments, the one or more process parameters include a plurality of process parameters, and the one or more predetermined features include a plurality of predetermined features, wherein determining the at least one second index indicating the at least one second degree of likelihood comprises determining a plurality of second indices respectively indicating the second degrees of likelihood of the candidate processing apparatus being the source of the anomaly in the target product, and wherein determining the at least one first index indicating the at least one first degree of likelihood comprises determining a plurality of first indices respectively indicating the first degrees of likelihood of the candidate processing apparatus being the source of the anomaly in the target product.

In some embodiments, determining the at least one first index comprises: determining a probability density function of the first reference set of the measurement data obtained for the remaining products among the set of products: determining a representative value of the measurement data obtained for the subset of one or more products among the set of products that have traversed the candidate processing apparatus; and determining the at least one first degree of likelihood of the candidate processing apparatus being the source of the anomaly in the target product based on the representative value and the probability density function of the first reference set.

In some embodiments, determining the at least one second index comprises: determining a probability density function of the second reference set of the sensor data for the candidate processing apparatus obtained from performing the corresponding manufacturing process on the one or more products among the plurality of products that have been processed before the target product by the candidate processing apparatus: acquiring the sensor data for the candidate processing apparatus obtained from performing the corresponding manufacturing process on the target product; and determining the at least one second degree of likelihood of the candidate processing apparatus being the source of the anomaly in the target product based on the sensor data for the candidate processing apparatus and the probability density function of the second reference set.

In some embodiments, outputting the indication of the one or more candidate processing apparatuses as the source of the anomaly in the target product comprises: outputting one or more first indices of a selected candidate processing apparatus among the one or more candidate processing apparatuses: outputting a first graph showing the measurement data obtained for the subset of one or more products among the set of products that have traversed the selected candidate processing apparatus and the first reference set of the measurement data obtained for the remaining products among the set of products: outputting one or more second indices of the selected candidate processing apparatus; and outputting a second graph showing the sensor data for the selected candidate processing apparatus obtained from performing the corresponding manufacturing process on the target product and the second reference set of the sensor data for the selected candidate processing apparatus obtained from performing the corresponding manufacturing process on the one or more products among the plurality of products that have been processed before the target product by the selected candidate processing apparatus.

In some embodiments, the determining in (c) comprises: (i) obtaining an anomaly score for each of the processing apparatuses: (ii) applying a trained machine learning model to each anomaly score to determine that at least one anomaly score is indicative of a processing apparatus being the source of the anomaly; and (iii) generating, based at least on the one anomaly score, one or more recommendations to correct the source of the anomaly.

In some embodiments, the trained machine learning model is obtained by: training the model using (1) a first and second subset of the sensor data, (2) a first and second subset of the measurement data, and (3) associating an anomaly score with each of the first and second subsets of the sensor data and/or the measurement data: validating the model on an independent subset of the sensor data and/or the measurement data associated with the processing apparatuses that have been determined to be sources of past anomalies; and selecting a threshold performance for the validated model such that the validated model determines the source of the anomaly within the threshold performance, wherein the threshold performance is associated with a mean squared error (MSE), a root mean squared error (RMSE), and/or a mean absolute error (MAE).

According to another aspect of the present disclosure, there is provided a method for determining a source of an anomaly in a manufacturing process, the method comprising: (a) receiving measurement data of one or more predetermined features associated with products of the manufacturing process; and (b) determining, based at least on the one or more predetermined features, an anomaly index indicative of a likelihood of a candidate processing apparatus being the source of the anomaly.

In some embodiments, the manufacturing process comprises one or more manufacturing processes sequentially performed by one or more sets of processing apparatuses, respectively, one manufacturing process being performed by one set of processing apparatuses independently.

In some embodiments, the measurement data comprises one or more predetermined features of each of the products after the one or more manufacturing processes have been performed on each of the products.

In some embodiments, the method further comprises between (a) and (b), upon detection of the anomaly in a target product among the products based on the measurement data, identifying one or more processing apparatuses among the processing apparatuses that have been traversed by the target product as candidate processing apparatuses.

In some embodiments, the method further comprises between (a) and (b), determining, for each candidate processing apparatus, at least one measurement data index indicating at least one degree of likelihood of the candidate processing apparatus being the source of the anomaly in the target product based on the measurement data obtained for a subset of one or more products among a set of products that have traversed the candidate processing apparatus and a reference set of the measurement data obtained for the remaining products among the set of products.

In some embodiments, the method further comprises between (a) and (b): receiving sensor data of one or more process parameters associated with processing apparatuses for carrying out the manufacturing process; and determining, for each candidate processing apparatus, at least one sensor data index indicating at least one second degree of likelihood of the candidate processing apparatus being the source of the anomaly in the target product based on the sensor data for the candidate processing apparatus obtained from performing the corresponding manufacturing process on the target product and a second reference set of the sensor data for the candidate processing apparatus obtained from performing the corresponding manufacturing process on one or more products among the plurality of products that have been processed before the target product by the candidate processing apparatus.

In some embodiments, determining the at least one measurement data index indicating the at least one degree of likelihood comprises comparing the measurement data obtained for the subset of one or more products among the set of products that have traversed the candidate processing apparatus and the reference set of the measurement data obtained for the remaining products among the set of products.

In some embodiments, the manufacturing process comprises one or more semiconductor manufacturing processes, the processing apparatuses comprise one or more processing chambers, and wherein the products comprise one or more semiconductor wafers.

In some embodiments, determining the at least one sensor data index indicating the at least one second degree of likelihood comprises comparing the sensor data for the candidate processing apparatus obtained from performing the corresponding manufacturing process on the target product and the second reference set of the sensor data.

In some embodiments, determining each of the at least one measurement data index comprises: determining a probability density function of the reference set of the measurement data obtained for the remaining products among the set of products: determining a representative value of the measurement data obtained for the subset of one or more products among the set of products that have traversed the candidate processing apparatus; and determining the at least one degree of likelihood of the candidate processing apparatus being the source of the anomaly in the target product based on the representative value and the probability density function of the reference set.

In some embodiments, determining each of the at least one sensor data index comprises: determining a probability density function of the second reference set of the sensor data for the candidate processing apparatus obtained from performing the corresponding manufacturing process on the one or more products among the plurality of products that have been processed before the target product by the candidate processing apparatus: acquiring the sensor data for the candidate processing apparatus obtained from performing the corresponding manufacturing process on the target product; and determining the at least one second degree of likelihood of the candidate processing apparatus being the source of the anomaly in the target product based on the sensor data for the candidate processing apparatus and the probability density function of the second reference set.

In some embodiments, the method further comprising after (b), outputting an indication of one or more candidate processing apparatuses as the source of the anomaly in the target product based on the at least one measurement data index and/or the at least one sensor data index.

In some embodiments, outputting the indication of the one or more candidate processing apparatuses as the source of the anomaly in the target product comprises: outputting one or more measurement data indices of a selected candidate processing apparatus among the one or more candidate processing apparatuses: outputting a first graph showing the measurement data obtained for the subset of one or more products among the set of products that have traversed the selected candidate processing apparatus and the reference set of the measurement data obtained for the remaining products among the set of products: outputting one or more sensor data indices of the selected candidate processing apparatus; and outputting a second graph showing the sensor data for the selected candidate processing apparatus obtained from performing the corresponding manufacturing process on the target product and the second reference set of the sensor data for the selected candidate processing apparatus obtained from performing the corresponding manufacturing process on the one or more products among the plurality of products that have been processed before the target product by the selected candidate processing apparatus.

In some embodiments, the method further comprises: determining, for each candidate processing apparatus, at least one measurement data type indicating a trend in the measurement data obtained for the subset of the one or more products among the set of products that have traversed the candidate processing apparatus by comparing a characteristic of a statistical distribution of the subset of the one or more products among the set of products that have traversed the candidate processing apparatus and the reference set of the measurement data obtained for the remaining products among the set of products.

In some embodiments, the method further comprises: generating a first route history of the target product along the candidate processing apparatuses: generating a second route history of a reference product along the candidate processing apparatuses; and calculating a route history index associated with the first route history and the second route history, wherein the route history index is indicative of a likelihood of the first route history being associated with the source of the anomaly.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF DRAWINGS

References will be made to embodiments of the present disclosure, examples of which may be illustrated in the accompanying drawings (also “Figure” and “FIG.” herein). The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 is a block diagram illustrating an example of a manufacturing system according to an embodiment of the present disclosure;

FIG. 2 illustrates a block diagram of a manufacturing process controller and an anomaly analysis controller connected to the manufacturing system according to an embodiment of the present disclosure:

FIG. 3 is a flowchart of a method performed by the anomaly analysis controller for determining a source of an anomaly in a plurality of manufacturing processes performed in the manufacturing system:

FIG. 4 illustrates a block diagram of a processor and a memory of the anomaly analysis controller according to an embodiment of the present disclosure:

FIG. 5 shows an example semiconductor manufacturing system as an example of the manufacturing system according to an embodiment of the present disclosure:

FIG. 6 shows a graph of thickness of a top layer of wafers measured by a measurement device during a metrology inspection:

FIG. 7A illustrates a graph of deviations, from the preset value, in thickness of a top layer of wafers processed by a candidate processing chamber and by other processing chambers of the manufacturing process P4 of FIG. 5:

FIG. 7B illustrates a graph of deviations, from the preset value, in thickness of a top layer of wafers processed by another candidate processing chamber and by other processing chambers of the manufacturing process P5 of FIG. 5:

FIG. 7C illustrates a graph of deviations, from the preset value, in thickness of a top layer of wafers processed by another candidate processing chamber and by other processing chambers of the manufacturing process P6 of FIG. 5:

FIG. 8A shows the graph of FIG. 7C and an inferred probability distribution graph of measurement data of the reference measurement dataset in FIG. 7C:

FIG. 8B shows the graph of FIG. 7C and an inferred probability distribution graph of measurement data of the measurement dataset of interest in FIG. 7C:

FIG. 9 shows a flowchart of measurement data anomaly analysis performed by the anomaly analysis controller for a processing apparatus traversed by a target product:

FIG. 10 shows a graph of sensor data of a processing chamber and an inferred probability distribution graph of a set of sensor data for the processing chamber obtained from performing the manufacturing process P6 of FIG. 5 on wafers that have been processed before a target wafer by the processing chamber:

FIG. 11 shows a flowchart of sensor data anomaly analysis performed by the anomaly analysis controller for a processing apparatus traversed by a target product; and

FIG. 12 shows a user interface that displays an indication of a candidate processing chamber performing a manufacturing process as a source of an anomaly in a target wafer based on a measurement data anomaly index and a sensor data anomaly index.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent that the present disclosure may be practiced without these specific details. In other instances, well-known methods, procedures, systems, and components have not been described in detail so as not to unnecessarily obscure aspects of the various embodiments.

Hereinafter, non-limiting embodiments of the present disclosure will be described with reference to the accompanying drawings. In all of the accompanying drawings, the same or corresponding members or components will be denoted by the same or corresponding reference numerals, and redundant explanations will be omitted.

Recognized herein is a need for improving systems and methods for determining sources of anomalies in manufacturing processes. In an aspect, disclosed herein are methods for determining a source of an anomaly in a manufacturing process, comprising: (a) receiving sensor data of one or more process parameters associated with processing apparatuses for carrying out the manufacturing process: (b) receiving measurement data of one or more predetermined features associated with products of the manufacturing process; and (c) determining, based at least on the one or more process parameters and/or the one or more predetermined features, an anomaly index indicative of a likelihood of a candidate processing apparatus being the source of the anomaly.

Unlike conventional systems and methods, systems and methods described herein provide for identifying or selecting candidate processing apparatuses (e.g., processing chambers, processing units, and the like) that are possible sources of anomalies, (e.g., a wafer with predetermined features that do not meet predetermined thresholds), which can be advantageous to reduce troubleshooting costs and improve return on investment.

Unlike conventional systems and methods, systems and methods described herein provide for determining a target product and processing apparatuses that the target product has passed through, e.g., a path or route history. Systems and methods described herein can combine advanced statistical methods to generate estimated probability distributions and/or machine learning models, e.g., anomaly detection using measurement data and/or anomaly detection using sensor data, which can be advantageous in improving the likelihood of identifying the source of an anomaly. For example, measurement data of products that have passed through the processing apparatuses can be statistically compared with measurement data of products that have passed through other processing apparatuses in the same process. For example, sensor data of other products associated with processing apparatuses can be statistically compared with sensor data of the target product associated with the processing apparatuses.

Unlike conventional systems and methods, systems and methods described herein can utilize domain knowledge of humans (e.g., field or process engineers) when training machine learning models, which can be advantageous in improving the likelihood of identifying the source of an anomaly. For example, anomaly indices for a reference dataset can be generated or received by field engineers for training machine learning models.

Unlike conventional systems and methods, systems and methods described herein can determine and use a path or route history of products through processing apparatuses in addition to measurement data or sensor data. The path or route history can be used to generate a route history index. The route history index can be combined with a measurement data index and/or a sensor data index using advanced statistical methods and/or machine learning models. For example, systems and methods describe herein can analyze all processes together instead of analyzing only a specific process at a specific time. This can be advantageous in improving the likelihood of identifying the source of an anomaly when modern manufacturing processes can comprise many processes which are strongly correlated to each other with inter-connected data.

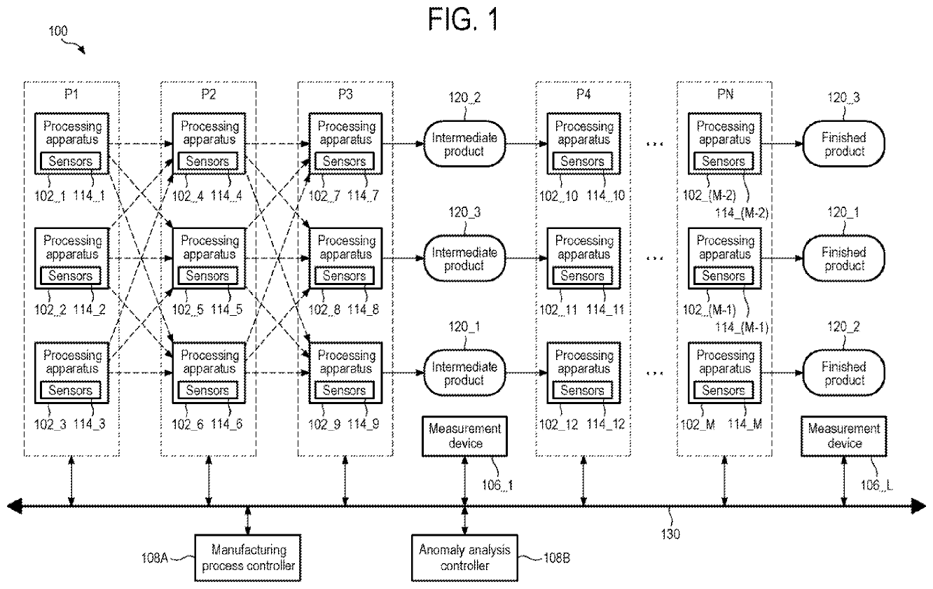

FIG. 1 is a block diagram illustrating an example of a manufacturing system 100 according to one embodiment of the present disclosure. The manufacturing system 100 performs a plurality of manufacturing processes P1 to PN, where N may be any suitable integer number, on base materials or parts (e.g., semiconductor substrates, unprocessed products, or the like) to produce products 120_1 to 120_3, as finished products. The manufacturing system 100 includes a plurality of processing apparatuses 102_1 to 102_M where M may be any suitable integer number.

As used herein, the term “product” refers to an object that may be processed to produce a finished product and includes any one of a material, a thing, an intermediate product made upon performing one or more manufacturing processes, a final product resulting from such manufacturing processes, or the like. For example, a product may include a semiconductor wafer or substrate that is subjected to a plurality of semiconductor processes for producing a finished wafer or substrate. The present disclosure is applicable to any suitable manufacturing processes that can produce finished products by performing a series of processes such as oxidation, photolithography, etching, implantation, deposition, and the like.

In the manufacturing system 100, the manufacturing processes P1 to PN are performed respectively by a plurality of sets (e.g., N sets) of the processing apparatuses 102_1 to 102_M in sequence. For example, the processing apparatuses 102_1, 102_2, and 102_3 may perform the manufacturing process P1 on products 120 (e.g., unprocessed products 120_1, 120_1, and 120_3), respectively, to produce intermediate products 120 (e.g., partially processed or unfinished products), on which subsequent manufacturing processes P2 to PN may be sequentially performed by the processing apparatuses 102_4 to 102_M to produce products 120 as finished products 120_1, 120_2, and 120_3. For example, the manufacturing process P1 may be performed on the products 120_1, 120_2, and 120_3 by a first set of the processing apparatuses 102_1, 102_2, and 102_3, respectively, the manufacturing process P2 may be performed on the products 120_3, 120_1, and 120_2 by a second set of the processing apparatuses 102_5, 102_4, and 102_6, respectively, the manufacturing process P3 may be performed on the products 120_2, 120_3, and 120_1 by a third set of the processing apparatuses 102_7, 102_8, and 102_9, respectively, the manufacturing process P4 may be performed on the products 120_1, 120_3, and 120_2 by a fourth set of the processing apparatuses 102_10, 102_11, and 102_12, respectively, and the manufacturing process PN may be performed on the products 120_3, 120_1, and 120_2 by an Nth set of the processing apparatuses 102_(M−2), 102_(M−1), and 102_M, respectively. Each processing apparatus 102_1 to 102_M independently performs the corresponding manufacturing process.

Although the manufacturing system 100 performs the illustrated manufacturing processes P1 to PN, it may include one or more additional manufacturing processes between the manufacturing processes shown in FIG. 1. For example, one or more additional manufacturing processes may be provided before the manufacturing process P1, between manufacturing processes P2 and P3, and/or between manufacturing processes P4 and PN. Further, although each of the manufacturing processes P1 to PN is illustrated as being performed independently by three processing apparatuses, each manufacturing process may be performed by any suitable number of processing apparatuses and the numbers of processing apparatuses for the manufacturing processes 1 to N may be the same or different from one another.

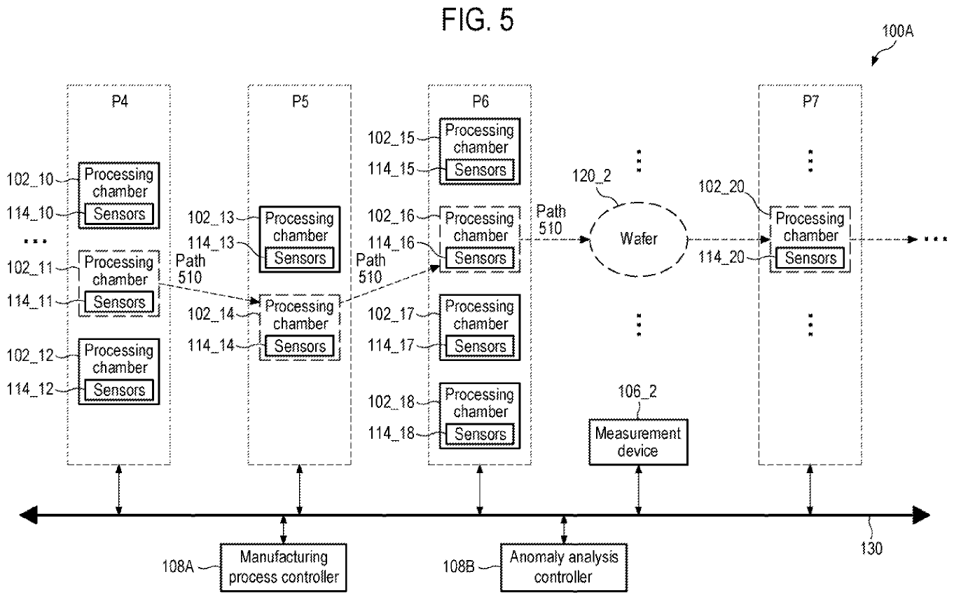

For example, the manufacturing process P1 may be performed by a set of three processing apparatuses, the manufacturing process P2 may be performed by a set of two processing apparatuses, and the manufacturing process P3 may be performed by a set of four processing apparatuses (see e.g., FIG. 5). In addition, the number of products 120 is not limited to three and may be any number of products suitable for the manufacturing system 100 and/or the manufacturing processes P1 to PN.

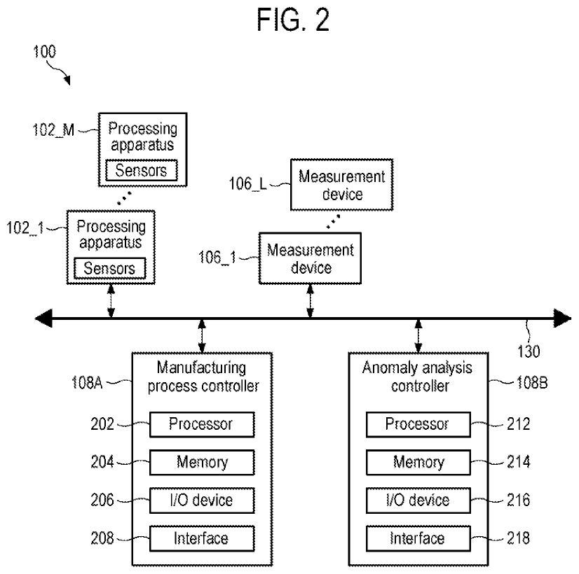

The manufacturing system 100 includes a manufacturing process controller 108A that controls overall operations of the manufacturing system 100 including the manufacturing processes P1 to PN performed in the processing apparatuses 102_1 to 102_M and the transfer of the products from one processing apparatus to another processing apparatus between adjacent manufacturing processes. The manufacturing process controller 108A may be, for example, a computer or a server connected wirelessly or by wire to the processing apparatuses 102_1 to 102_M and a plurality of measurement devices 106_1 to 106_L. For example, the manufacturing process controller 108A may communicate with the processing apparatuses 102_1 to 102_M and the measurement devices 106_1 to 106_L via a bus 130. The manufacturing process controller 108A may include a processor (e.g., a CPU, one or more processors, or the like) and a memory such as a random access memory (RAM), a read only memory (ROM), a mass storage device (e.g., a hard drive, a solid state drive, etc.), and/or the like as will be described in more detail later with reference to FIG. 2. The processor of the manufacturing process controller 108A operates by executing programs loaded into the RAM from the ROM or the mass storage device to control each part of the manufacturing system 100.

In FIG. 1, the manufacturing process controller 108A controls operations of the manufacturing system 100 to perform the manufacturing processes P1 to PN for producing the finished products 120-1, 120_2, and 120-3. The manufacturing process controller 108A may also control a plurality of transfer devices (not shown) to transfer products from one processing apparatus of one manufacturing process to another processing apparatus of a next manufacturing process. In this manner, each of the products (e.g., an intermediate product or a final product) traverses a path (e.g., a path or route history) defined by a sequence of processing apparatuses in which the product is processed under the control of the manufacturing process controller 108A.

For example, in the manufacturing system 100 shown in FIG. 1, the manufacturing process controller 108A may control the processing apparatuses 102_1 to 102-M and transfer devices (not shown) to perform the manufacturing processes P1 to PN on the product 120_1 along a path defined by the processing apparatuses 102_1, 102_4, 102_9, 102_12 . . . and 102_(M−1), respectively; perform the manufacturing processes P1 to PN on the product 120_2 along a path defined by the processing apparatuses 102_2, 102_6, 102_7, 102_10 . . . and 102_M, respectively; and perform the manufacturing processes P1 to PN on the product 120_3 along a path defined by the processing apparatuses 102_3, 102_5, 102_8, 102_11 . . . and 102_(M−2), respectively. Although the products 120 are described as traversing the above paths, the manufacturing process controller 108A may use any other suitable paths for the products 120 to perform the manufacturing processes P1 to PN. The controller 108A may store the path traversed by each of the products 120_1, 120_2, and 120_3 in the memory 112, for example, as metadata of the corresponding product.

In the course of performing the manufacturing processes P1 to PN, the products 120_1, 120_2, and 120_3 may be checked periodically for potential anomalies. As shown in FIG. 1, the manufacturing system 100 may include a plurality of measurement devices 106_1 to 106_L where L is an integer number greater than or equal to 1. Each of the measurement devices 106_1 to 106_L may be provided for performing a metrology inspection on one or more products 120 after a predetermined manufacturing process among the manufacturing processes P1 to PN.

As shown in FIG. 1, the measurement device 106_1 may be provided after the manufacturing process P3 and each of the subsequent measurement devices 106_2 to 106_L may be provided after a predetermined manufacturing process. Alternatively, the measurement devices 106_1 to 106_L may be provided in any suitable intervals of the manufacturing processes 1 to N. For example, one or more measurement devices 106 may be provided after each of the manufacturing processes 1 to N or after two or more manufacturing processes (e.g., two, three, four, or the like) in equal or unequal intervals. One or more measurement devices 106 may be provided after a predetermined manufacturing process, or in equal or unequal intervals.

Upon completion of the manufacturing process P3, the measurement device 106_1 may perform a metrology inspection by measuring the products 120_1, 120_2, and 120_3, which are intermediate products output from the processing apparatuses 102_9, 102_7, and 102_8, respectively. For example, the measurement device 106_1 may measure one or more parameter values of predetermined features (e.g., feature parameters) in each of the intermediate products 120_1, 120_2, and 120_3 and obtain measurement data of the predetermined features for each of the intermediate products 120_1 to 120_3. Alternatively, at least one of the products 120_1 to 120_3 may be selected and the measurement device 106_1 may perform measurements on the selected at least one intermediate product to obtain measurement data for each selected product. As used herein, the term “feature” may refer to any physical characteristic such as a thickness, depth, length, radius, and/or the like of a product resulting from one or more manufacturing processes. For example, in the case of semiconductor manufacturing processes, a feature may include a critical dimension of a pattern or a structure in a semiconductor substrate or wafer.

In one embodiment, may be implemented with a camera capable of capturing images including the predetermined features of the products. The measurement devices 106_1 to 106L may analyze the captured images and determine parameter values of the predetermined features. Alternatively, the measurement devices 106_1 to 106L may provide the captured images to the manufacturing process controller 108A, which may determine parameter values of the predetermined features from the captured images.

The measurement data of one or more measured products from the measurement devices 106_1 to 106L may be provided to the manufacturing process controller 108A via the bus 130. The manufacturing process controller 108A may analyze the measurement data of the products 120_1 to 120_3 and identify abnormal measurement data that fall outside an allowable range by using, for example, a statistical process control (SPC) method. If the manufacturing process controller 108A detects abnormal measurement data for one or more products, which may be referred to herein as a “target product” or “target products” of interest for which an anomaly has been detected, the controller 108A may generate an alarm (e.g., an SPC alarm) and output the alarm to flag the anomaly of the target product or target products. When such an alarm is generated, the manufacturing system 100 may be halted so that the source of the anomaly in a processing apparatus that has performed a process on the target product or a process parameter in a manufacturing process that has been performed on the target product may be determined, and appropriate actions to address the source of the anomaly may be taken before proceeding to perform the next manufacturing process (e.g., the manufacturing process P4).

In the manufacturing system 100, the processing apparatuses 102_1 to 102_M may include sensors 114_1 to 114_M, respectively. The sensors 114_1 to 114_M may be provided inside or outside the processing apparatuses 102_1 to 102_M, respectively, and are configured to detect one or more process parameters such as temperature, pressure, power, flow rates of process materials, and the like in the processing apparatuses 102_1 to 102_M, respectively. When each of the processing apparatuses 102_1 to 102_M performs a corresponding manufacturing process on a product 120, the sensors 114 of the processing apparatus 102 may provide parameter values of detected process parameters to an anomaly analysis controller 108B, which is a computing apparatus, via the bus 130 for storage in memory (to be described in detail with reference to FIG. 2) as sensor data indicative of a state of the processing apparatus 102. In another example, the sensors 114 of the processing apparatus 102 may provide parameter values of detected process parameters to the manufacturing process controller 108A via the bus 130 for storage in a memory.

In the course of performing the manufacturing processes P1 to PN on a plurality of products 120 (e.g., a batch or lot of any number of semiconductor wafers, etc.) in the manufacturing system 100, the measurement data obtained by the measurement devices 106 from a set of the products 120 (selected among the plurality of products 120 in a predetermined manner) which have been processed by one or more processing apparatuses 102 may be provided to the manufacturing process controller 108A and stored as a measurement dataset for the set of products 120. Further, the sensor data obtained by the sensors 114 from each of a plurality of processing apparatuses 102 in which the plurality of products 120 have been processed may be provided to the anomaly analysis controller 108B and stored as a sensor dataset for the plurality of processing apparatuses 102. In one embodiment, one measurement dataset may be provided for each type of predetermined features (e.g., thickness, depth, etc.) and one sensor dataset may be provided for each type of process parameters (e.g., temperature, pressure, power, flow rate, etc.).

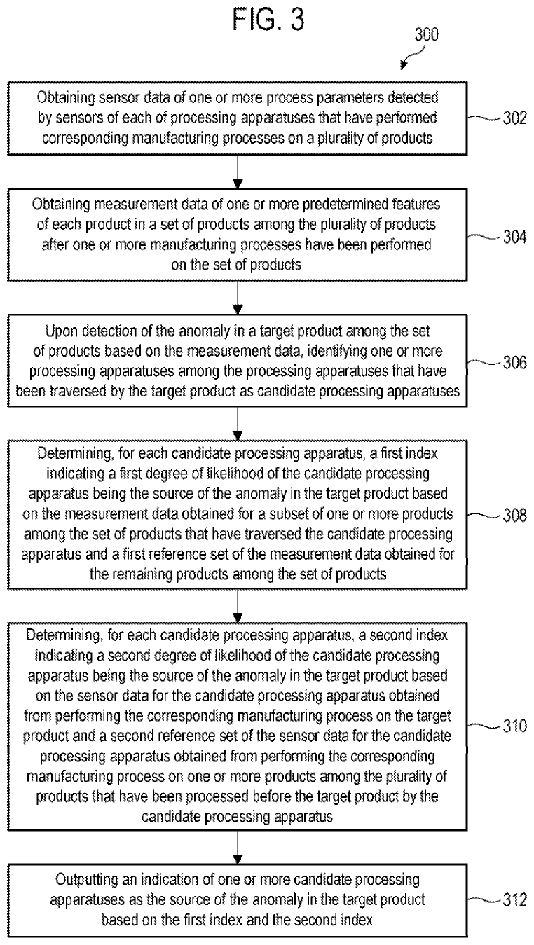

Upon detection of an anomaly in a product 120 (e.g., generation of an SPC alarm by the manufacturing process controller 108A) based on measurement data of the product 120 (hereinafter, a “target product” or an “alarmed product”), the anomaly analysis controller 108B may obtain the measurement data of the set of products 120 from the product batch or lot that have been processed and measured by one or more measurement devices 106 and the sensor data of the processing apparatuses 102 that have performed manufacturing processes from the respective sensors 114, and determine one or more candidate processing apparatuses among the plurality of processing apparatuses 102 as a source of the anomaly of the target product using a method illustrated, for example, in FIG. 3. Upon determining a candidate processing apparatus as a source of the anomaly, the corresponding manufacturing process performed by the candidate processing apparatus may also be determined to be a source of the anomaly. In one embodiment, both the measurement data and the sensor data may be used to determine the source of the anomaly. In another embodiment, either the measurement data or the sensor data may be used to determine the source of the anomaly.

For example, with reference to FIG. 1, while performing the manufacturing processes P1 to PN on a product batch or lot, the measurement device 106_1 may select and measure one or more predetermined features of the intermediate product 120_3 and provide the measured data to the manufacturing controller 108A. Based on the measured data of the predetermined features, the manufacturing controller 108A may determine one or more of the measured values to be abnormal and generate an alarm indicating an anomaly in the target product (for notifying a process engineer via a user interface). In response to the alarm, the anomaly analysis controller 108B may obtain the measurement data of the products 120 of the product batch or lot that have been processed and measured by the measurement devices 106_1 and the sensor data of the processing apparatuses 102 that have performed manufacturing processes on the intermediate product 120_3 from the respective sensors 114, and determine one or more candidate processing apparatuses among the plurality of processing apparatuses 102 traversed by the intermediate product 120_3 as a source of the anomaly of the target product.

The anomaly analysis controller 108B may also output an indication of the one or more candidate processing apparatuses as the source of the anomaly in the target product (e.g., the intermediate product 120_3). The information output from the anomaly analysis controller 108B may make it easier for process engineers to identify a processing apparatus 120 among the candidate processing apparatuses as the source of the anomaly and perform corrective measures. In some cases, performing corrective measures may include correcting the source of the anomaly associated with process parameters, e.g., correcting temperature, pressure, power, flow rates of process materials, and the like of a processing apparatus. In some cases, performing corrective measures can include examining one or more processing apparatuses traversed by the target product e.g., a path of a wafer along the processing apparatuses of the manufacturing process.

Subsequently, each of the intermediate products 120_1 to 120_3 may be transferred to one of the processing apparatuses 102_10, 102_11, and 102_12 of the fourth set under control of the manufacturing process controller 108A for performing the next manufacturing process P4. Thereafter, the products 120_1 to 120_3 may go through the manufacturing processes P5 to P(N-1), which are omitted for ease of illustration and explanation, in a similar manner as in previous manufacturing processes. Further, the measurement devices 106_2 to 106_(L-1), which perform measurements similar to the measurement device 106_1, may be provided after the manufacturing process P4 and before the manufacturing process N in any suitable intervals.

The manufacturing process PN may be performed by each of the processing apparatuses 102_(M−2), 102_(M−1), and 102_M on the intermediate products to produce the products 120_1, 120_2, and 120_3, which are finished products. Once the manufacturing process PN has been performed, one or more of the finished products 120_1 to 120_3, which have been output from the processing apparatuses 102_(M−2), 102_(M−1), and 102_M, may be measured by the measurement device 106_L in a similar manner as the measurement device 106_1 described above for detecting an anomaly by the manufacturing process controller 108A and for determining a source of the anomaly by the anomaly analysis controller 108B.

FIG. 2 illustrates a more detailed block diagram of the manufacturing process controller 108A and the anomaly analysis controller 108B connected to the manufacturing system 100 via the bus 130 according to an embodiment of the present disclosure. In the embodiments shown in FIGS. 1 and 2, the manufacturing process controller 108A and the anomaly analysis controller 108B, which may be implemented as a computing apparatus or system, are implemented as separate computer systems. However, the anomaly analysis controller 108 and the manufacturing process controller 108A may be implemented in a single computing apparatus or system or may be provided in or outside the manufacturing system 100.

The manufacturing process controller 108A includes a processor 202, a memory 204, an I/O device 206, and a communication interface 208. Similarly, the anomaly analysis controller 108B includes a processor 212, a memory 214, an I/O device 216, and a communication interface 218. The processors 202 and 212 (e.g., CPUs, processors, and the like) may execute instructions, a program, code, and the like to perform operations such as various calculations, processing, data generation, and processing related to the present disclosure. Also, the processors 202 and 212 may load instructions, programs, code, data, and the like from the memories 204 and 214, respectively, or may store data, etc. in the memories 204 and 214, respectively.

The memories 204 and 214 may store various types of data, instructions, programs, code and the like. The data stored in the memories 204 and 214 may be data obtained, processed, or used by at least one element of the manufacturing process controller 108A and the anomaly analysis controller 108B, respectively. The memories 204 and 214 may include a volatile and/or non-volatile memory. In the present disclosure, the memories 204 and 214 may store the instructions or programs, and may include an operating system for controlling resources of the manufacturing process controller 108A and the anomaly analysis controller 108B, respectively. In an embodiment, the memories 204 and 214 of the manufacturing process controller 108A and 108B, respectively, may store instructions which, when executed by the processors 202 and 212, respectively, cause the processors to perform calculation.

The interfaces 208 and 218 in the manufacturing process controller 108A and the anomaly analysis controller 108B, respectively, provide a function of interfacing with external devices, apparatuses, etc. The interfaces 208 and 218 may provide wireless or wired communication interface functions for the controllers 108A and 108B, respectively. The I/O devices 206 and 216 in the controllers 108A and 108B, respectively, allow input and/or output of data and/or control signals for a user and may include a keyboard, a mouse, a light pen, a track ball, a scanner, a microphone, a speaker, a display device, a touchscreen display, etc.

FIG. 3 is a flowchart of a method 300 performed by the anomaly analysis controller 108B for determining a source of an anomaly in a plurality of manufacturing processes performed in the manufacturing system 100. The manufacturing processes may be sequentially performed by one or more sets of processing apparatuses, respectively. Each manufacturing process may be performed by a set of one or more processing apparatuses that are configured to perform the manufacturing process independently of one another.

In this method, at 302, the anomaly analysis controller 108B obtains sensor data of one or more process parameters detected by the sensors 114 of each the plurality of processing apparatuses 102 that have performed corresponding manufacturing processes on the plurality of products 120. For example, the sensors 114 for a processing apparatus 102 may detect one or more process parameters (e.g., temperature, pressure, power, flow rates of process materials, and the like) when the processing apparatus 102 performs the corresponding manufacturing process on a product 120, and provide values of the detected process parameters to the anomaly analysis controller 108B for storage in the memory 214 immediately or after an alarm is generated by the manufacturing process controller 108A.

At 304, the anomaly analysis controller 108B obtains measurement data of one or more predetermined features of each product in a set of products among the plurality of products after the one or more the manufacturing processes have been performed on the set of products. For example, the measurement device 106 may periodically perform measurements (as part of a metrology inspection) on the set of products among the plurality of products and generate measurement data of the products 120. The anomaly analysis controller 108B may then obtain the measurement data of the products 120 of the product batch or lot that have been processed and measured by one or more measurement devices 106 from the manufacturing process controller 108A.

At 306, upon detection of an anomaly in a target product (for example, by performing a metrology inspection), the anomaly analysis controller 108B identifies one or more processing apparatuses among the processing apparatuses that have been traversed by the target product as candidate processing apparatuses. For example, when the manufacturing process controller 108A generates an alarm indicating an anomaly in a target product based on the measurement data of the target product, the anomaly analysis controller 108B may determine a path traversed (e.g., a path or route history) by the target product by identifying one or more processing apparatus, in which the target product was processed, as candidate processing apparatuses based on path data of the products that have been processed in the manufacturing system 100 including path data of the target product. For example, the manufacturing process controller 108A may store path data constituting a sequence of processing apparatuses that each product has traversed as a path dataset in the memory 204 and provide the path data to the anomaly analysis controller 108B for storage in the memory 214. Based on the path data of the target product, the anomaly analysis controller 108B may determine one or more processing apparatuses that have been traversed by the target device as candidate processing apparatuses, which may be a potential source of the anomaly in the target product.

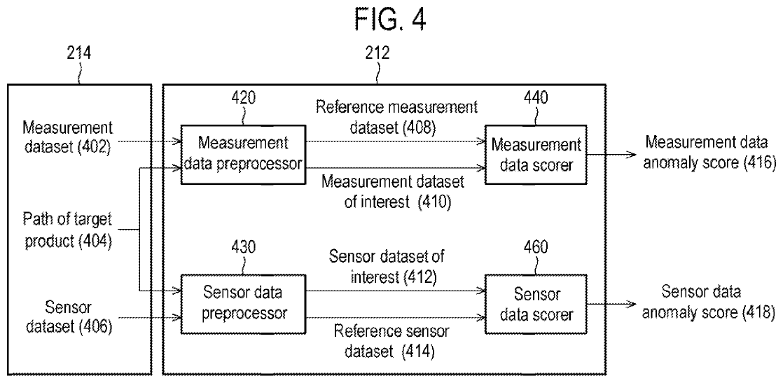

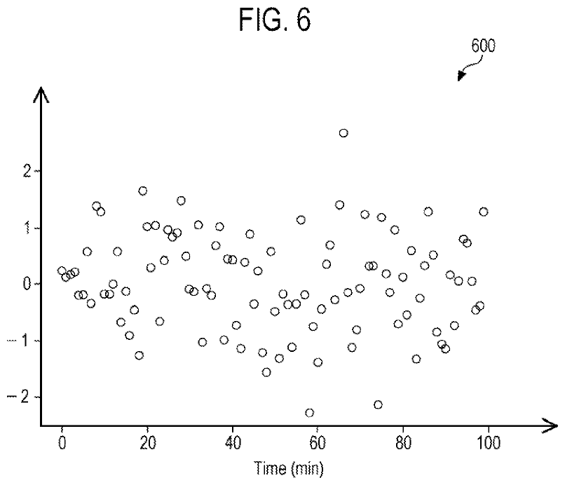

At 308, the anomaly analysis controller 108B determines, for each candidate processing apparatus, at least one first index (e.g., one or more measurement data indices) indicating at least one degree of likelihood of the candidate processing apparatus being the source of the anomaly in the target product based on the measurement data obtained for a subset of one or more products among the set of products that have traversed the candidate processing apparatus (see measurement dataset of interest 410 described herein with reference to FIG. 4) and a first reference set of the measurement obtained for the remaining products among the set of products (see reference measurement dataset 408 described herein with reference to FIG. 4). Each first index may indicate a degree of likelihood of the corresponding candidate processing apparatus being a source of the anomaly in the target product. In one embodiment, the anomaly analysis controller 108B may determine the at least one first index by comparing the measurement data obtained for the subset of one or more products that have traversed the candidate processing apparatus and the first reference set of the measurement obtained for the other products among the set of products. Details for determining a first index is described herein with reference to FIGS. 6 to 9.

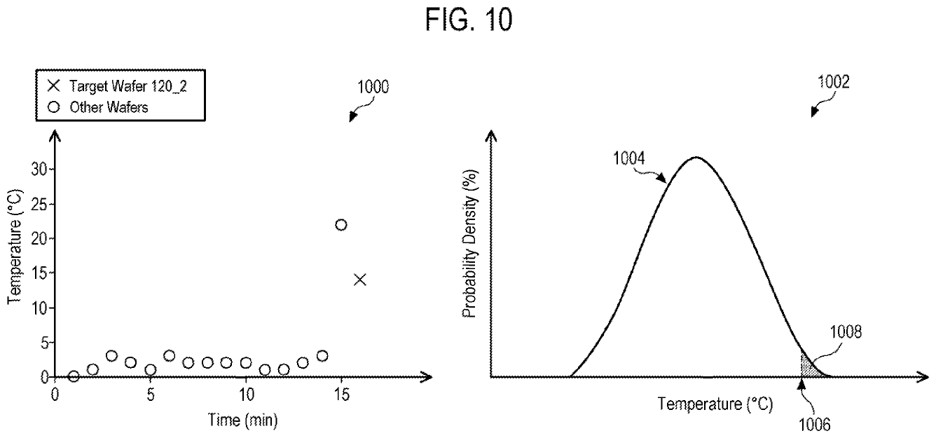

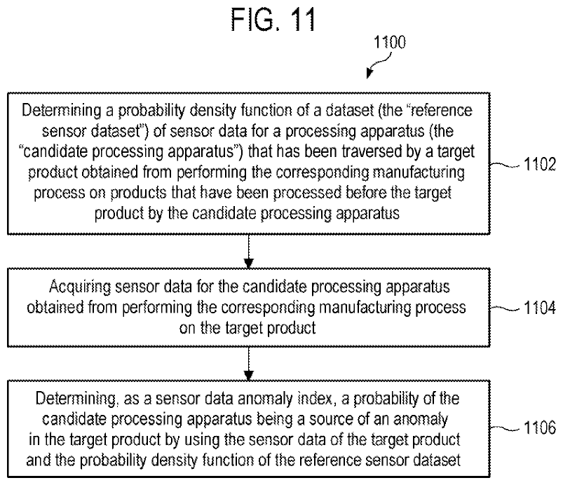

At 310, the anomaly analysis controller 108B determines, for each candidate processing apparatus, at least one second index (e.g., one or more sensor data indices) indicating at least one degree of likelihood of the candidate processing apparatus being a source of the anomaly in the target product based on the sensor data for the candidate processing apparatus obtained from performing the corresponding manufacturing process on the target product (see e.g., sensor dataset of interest 412 described herein with reference to FIG. 4) and a second reference set of the sensor data for the candidate processing apparatus obtained from performing the corresponding manufacturing process on one or more products among the plurality of products that have been processed before the target product by the candidate processing apparatus (see e.g., reference sensor dataset 414 described herein with reference to FIG. 4). Each second index may indicate a degree of likelihood of the corresponding candidate processing apparatus being a source of the anomaly in the target product. In one embodiment, the anomaly analysis controller 108B may determine the at least one second index by comparing the sensor data obtained from performing the corresponding manufacturing process on the target product by the candidate processing apparatus and the second reference set of the sensor data for the candidate processing apparatus obtained from performing the corresponding manufacturing process on one or more products among the plurality of products that have been processed before the target product by the candidate processing apparatus. Details for determining a second index is described herein with reference to FIGS. 10 and 11.

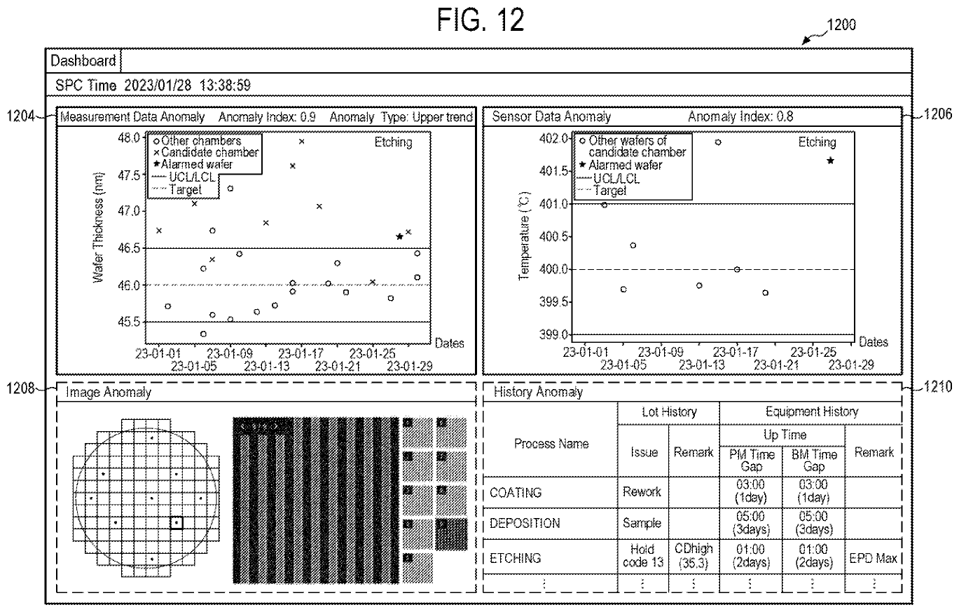

At 312, the anomaly analysis controller 108B outputs an indication of the one or more candidate processing apparatuses as the source of the anomaly in the target product based on the at least one first index and the at least one second index. An example of a user interface showing the indication of the one or more candidate processing apparatuses as the source of the anomaly in the target product based on the at least one first index and the at least one second index is described herein with reference to FIG. 12.

The information output from the anomaly analysis controller 108 can facilitate and expedite determination of one or more processing apparatuses among the candidate processing apparatuses as the source of the anomaly in the target product (e.g., the alarmed product). Thus, not only the time for correcting the source of the anomaly but also the time that the manufacturing system is offline may be reduced substantially. Accordingly, the manufacturing system 100 may operate in a more efficient manner in performing the manufacturing processing processes P1 to PN.

Although the method 300 is illustrated as performing acts 302 to 312 sequentially, the method 300 is not limited to the illustrated sequence and may be performed in any suitable sequence. For example, determining the at least one second index at 310 may be performed before or simultaneously with determining the at least one first index at 308, or obtaining the process parameters at 302 may be performed simultaneously or after obtaining the measurements of predetermined features at 304. In some embodiments, the method 300 may be performed without obtaining measurement data and without determining the at least one first index at 304 and 308 or without obtaining sensor data and without determining the at least one second index at 306 and 310.

FIG. 4 illustrates a block diagram of the processor 212 and the memory 214 of the anomaly analysis controller 108B according to one embodiment of the present disclosure. The memory 214 of the controller 108B stores a measurement dataset 402, a path 404 of target product, and a sensor dataset 406 obtained from manufacturing processes that have been performed on a plurality of products in the manufacturing system 100. The measurement dataset 402 may include the measurement data of one or more predetermined features of each product in a set of products among the plurality of products that have been measured by the measurement devices 106 in the manufacturing system 100. The measurement dataset 402 includes measurement data of the latest target product (e.g., a target product of interest) in which an anomaly has been detected and thus caused an alarm.

The path 404 of target product includes a path defined by one or more processing apparatuses that have been traversed by the target product of interest which has caused an alarm such that each of the one or more processing apparatuses may be identified as a candidate processing apparatus. For example, with reference FIG. 1, the path 404 of the target product 120_3 may include one or more processing apparatuses 102_3, 102_5, and 102_8 in which the target product 120_3 has been processed in the manufacturing system 100. In some embodiments, the path 404 of a target product may include a path traversed by the target product from a processing apparatus of the first manufacturing process or a path traversed from a processing apparatus after a previous metrology inspection to a processing apparatus immediately before the metrology inspection that triggered the alarm.

The sensor dataset 406 may include the sensor data of one or more process parameters detected by the sensors 114 of the processing apparatuses 102 that have performed corresponding manufacturing processes on a plurality of products 120 in the manufacturing system. For example, the sensor data of the sensor dataset 406 may include one or more process parameters detected by the sensors 114 of the processing apparatuses 102 that have performed associated manufacturing processes on the plurality of products 120 including the sensor data of the target product of interest that has triggered an alarm and the sensor data of other products among the plurality of products. That is, the sensor data of the sensor dataset 406 may include sensor data of the target product of interest that has triggered an alarm and the sensor data of the other products among the plurality of products that were processed before the target product of interest. These products processed before the target product of interest may be products processed during a predetermined period of time before the processing of the target product of interest, or a predetermined number of products processed immediately before the target product of interest. The memory 214 may receive the measurement dataset 402 and the path 404 of the target product from the memory 204 of the manufacturing process controller 108A and the sensor dataset 406 from the sensors 114. In another example, the memory 214 may receive the sensor dataset 406 from memory 204 of the manufacturing process controller 108A.

The processor 212 of the anomaly analysis controller 208B is configured to function as a measurement data preprocessor 420, a sensor data preprocessor 430, a measurement data scorer 440, and a sensor data scorer 450 by loading corresponding programs, code, or the like from the memory 214. The measurement data preprocessor 420 receives the measurement dataset 402 and the path 404 of the target product and generates a measurement dataset of interest 410 and a reference measurement dataset 408. The measurement dataset of interest 410 may be generated for each of the processing apparatuses identified in the path 404 of the target product of interest as a candidate processing apparatus, and may include measurement data obtained for a subset of one or more products among the set of products that have traversed the candidate processing apparatus. The reference measurement dataset 408 may include measurement data obtained for the other remaining products among the set of products that have not traversed the candidate processing apparatus. Based on the reference measurement dataset 408 and the measurement dataset of interest 410, the measurement data scorer 440 may generate a measurement data anomaly score 416 indicating a degree of likelihood of the candidate processing apparatus being the source of the anomaly. For example, the degree of likelihood may be represented by a numerical value such as a decimal value greater than or equal to 0 and less than or equal to 1. The higher the decimal value, the higher the likelihood of the candidate processing apparatus being the source of the anomaly.

The sensor data preprocessor 430 receives the sensor dataset 406 of process parameters and the path 404 of the target product, and generates a sensor dataset of interest 412 and a reference sensor dataset 414. The sensor dataset of 412 may be generated for each of the processing apparatuses identified in the path 404 of the target product of interest as a candidate processing apparatus, and may include sensor data for the candidate processing apparatus obtained from performing the corresponding manufacturing process on the target product of interest. The reference sensor dataset 414 may include sensor data for the candidate processing apparatus obtained from performing the corresponding manufacturing process on one or more products among the plurality of products that have been processed before the target product by the candidate processing apparatus. Based on the sensor dataset of interest 412 and the reference sensor dataset 414, the sensor data scorer 450 may generate a sensor data anomaly score 418 indicating a degree of likelihood of the candidate processing apparatus being the source of the anomaly, similar to the measurement data anomaly score 416.

FIG. 5 shows a semiconductor manufacturing system 100A as an example of the manufacturing system 100 according to an embodiment of the present disclosure. Although the semiconductor manufacturing system 100A is provided as an example of the manufacturing system 100, the present disclosure is applicable to any suitable manufacturing systems in which manufacturing processes can be performed in sequence with each manufacturing processes being performed by a set of one or more processing apparatuses such as processing chambers, processing units, and/or the like. For example, the present disclosure may be applied to other manufacturing systems that perform a plurality of processes sequentially in a plurality of processing units to manufacture battery modules or packs, display panels, semiconductor packaging, and the like.

In FIG. 5, the first three semiconductor processes P1 to P3 of the semiconductor manufacturing system 100A, which may correspond to the manufacturing processes P1 to P3 of the manufacturing system 100, are omitted for ease of description, but the operation of the processing sequences and traversal of the processing apparatuses in FIG. 1 are equally applicable to the processing sequences and traversal of the semiconductor manufacturing system 100A. The remaining semiconductor processes P4 to PN where N is an integer greater than 1 in the semiconductor manufacturing system 100A may be performed on target products, which are semiconductor wafers or substrates, in a similar manner as in the manufacturing processes P4 to PN in FIG. 1, respectively. The semiconductor processes P1 to PN may include any suitable semiconductor processes such as deposition, etching, lithography, resist formation, oxidation, and the like.

Among others, the semiconductor manufacturing system 100A includes a first set of processing chambers (e.g., processing chambers 102_10, 102_11, and 102_12) which are configured to independently perform the semiconductor process P4, a second set of processing chambers (e.g., processing chambers 102_13 and 102_14) configured to independently perform the semiconductor process P5, a third set of processing chambers (e.g., processing chambers 102_15, 102_16, 102_17, and 102_18) configured to perform the semiconductor process P6, and a fourth set of processing chambers (e.g., processing chamber 102_20, etc.) configured to perform the semiconductor process P7.

For ease of description, FIG. 5 illustrates only the wafer 120_2 as a target wafer subjected to a metrology inspection by the measurement device 106_2 after the semiconductor process P6. When subjected to the metrology inspection, the wafer 120_2 has traversed along a path 510 that includes processing chambers 102_11, 102_14, and 102_16, which have performed semiconductor processes P4, P5, and P6, respectively, on the wafer 120_2. Accordingly, the path 510 of the wafer 120_2 as the target wafer since the last metrology inspection may be defined as including the processing chambers 102_11, 102_14, and 102_16 as one or more candidate processing chambers.

In the semiconductor manufacturing system 100A, the measurement data of the target wafer 120_2 from the measurement device 106_2 may be provided, along with or in addition to the measurement data that have previously been obtained in the semiconductor manufacturing system 100A, to the anomaly analysis controller 108B via the manufacturing process controller 108A. In one embodiment, the measurement data of one or more wafers 120 that are subjected to a metrology inspection may be provided to the anomaly analysis controller 108B as the data are generated or as needed (e.g., upon request of the anomaly analysis controller 108B) upon detection of an anomaly in a target product.

Further, the sensor data of the processing chambers 102_11, 102_14, and 102_16 (e.g., candidate processing chambers) and other chambers 102_10, 102_12, 102_13, 102_15, 102_17, and 102_18 may be provided to the anomaly analysis controller 108B as the data are generated or upon detection of an anomaly in a target product (or when requested by the anomaly analysis controller 108B upon receiving an alarm indicating an anomaly in the target product). That is, the sensor data from the sensors 114 of the processing chambers 102, respectively, may be provided to the anomaly analysis controller 108B as the data are generated or as needed upon detection of an anomaly in a target product. In one embodiment, the sensor data from the sensors 114 of the processing chambers 102, respectively, may be provided to the manufacturing process controller 108A first, as the data are generated or as needed upon detection of an anomaly in a target product. Upon detection of an anomaly in the target product, the manufacturing process controller 108A may notify the anomaly analysis controller 108B of the anomaly and provide the sensor data to the anomaly analysis controller 108B (or the anomaly analysis controller 108B may request the sensor data from the manufacturing process controller 108A upon notification of the anomaly.) In addition, the path 510 of the wafer 120_2 may also be provided to the anomaly analysis controller 108B.

Based on the measurement data from measurement devices 106 and the path 510 of the target wafer 120, the anomaly analysis controller 108B may compare, for each candidate processing apparatus (e.g., processing chamber 102_16, 102_14, and/or 102_11), the measurement data obtained for a subset of one or more products (e.g., the wafer 120_2 and the like whose features have been measured by the measurement device 106_2) among the set of products that have traversed the candidate processing apparatus, and the measurement data obtained for the other products among the set of products. Based on the comparison, the controller 108B may generate at least one first index indicating at least one first degree of likelihood of the candidate processing apparatus being the source of the anomaly in the target wafer 120_2. Further, the controller 108B may generate an indication of one or more candidate processing apparatuses as a source of the anomaly in the target wafer 120_2 based on the at least one first index.

Additionally or alternatively, based on the sensor data from the processing chambers 102 and the path 510 of the target wafer 120_2, the anomaly analysis controller 108B may compare, for each candidate processing chamber (e.g., processing chamber 102_16, 102_14, and/or 102_11), the sensor data for the candidate processing apparatus obtained from performing the corresponding manufacturing process on the target wafer 120_2 and the sensor data for the candidate processing apparatus obtained from performing the corresponding manufacturing process on one or more products among the plurality of products that have been processed before or previous to the target product by the candidate processing apparatus. Based on the comparison, the controller 108B may generate at least one second index indicating at least one second degree of likelihood of the candidate processing apparatus being the source of the anomaly in the target wafer 120_2. Further, the controller 108B may generate an indication of one or more candidate processing apparatuses as a source of the anomaly in the target wafer 120_2 based on the at least one second index.

In some embodiments, the controller 108B may output an indication of one or more candidate processing apparatuses as the source of the anomaly in the target wafer 120_2 based on either or both the at least one first index and the at least one second index.

### Anomaly Analysis

As described above, upon detection of an anomaly in a product (e.g., a target product), data (e.g., measurement data) indicative of physical features or characteristics of products and data (e.g., sensor data) indicative of process parameters for manufacturing processes may be analyzed to identify a candidate source of the anomaly in the target product. As the source of an anomaly, either or both a processing apparatus and/or a manufacturing process performed by the processing apparatus may be identified.

According to one embodiment of the present disclosure, whether a particular processing apparatus may be a source of an anomaly in a target product may be determined by analyzing measurement data of products that have been processed by a processing apparatus (e.g., a candidate processing apparatus) against measurement data of products processed by other processing apparatuses in the same manufacturing process, and by determining a degree of likelihood of the candidate processing apparatus being the source of the anomaly in the target product based on the data analysis (hereinafter, “measurement data anomaly analysis”).

According to another embodiment of the present disclosure, whether a particular manufacturing process performed by a candidate processing apparatus can be a source of an anomaly may be determined by analyzing sensor data of a process parameter for the manufacturing process performed on the target product by the candidate processing apparatus against sensor data of the same process parameter performed on products processed immediately before the target product by the candidate processing apparatus, and by determining a degree of likelihood of the candidate processing apparatus on the target product being the source of the anomaly based on the data analysis (hereinafter, “sensor data anomaly analysis”).

### Measurement Data Anomaly Analysis

In the measurement data anomaly analysis, a measurement data anomaly index (e.g., a first index or a measurement data index) is determined. The measurement data anomaly index is an index representing a degree of likelihood of a specific processing apparatus being a source of an anomaly in a target product based on measurement data of products. A measurement data anomaly index exceeding a threshold value or a predetermined number of top measurement data anomaly indices may be output as an indication of a processing apparatus being a source of the anomaly. A method for calculating a measurement data anomaly index for each processing apparatus in a path (e.g., a path or route history) of a target product is described herein in more detail with reference to FIGS. 6 to 9.

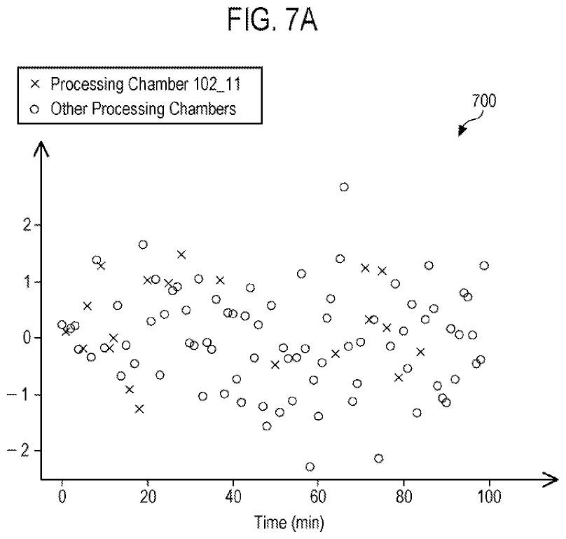

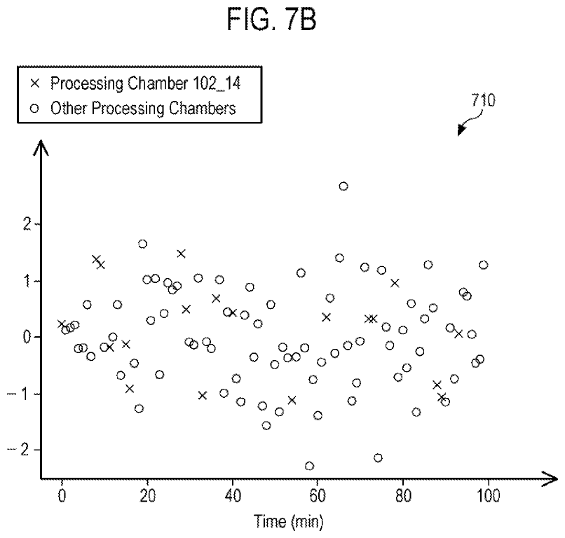

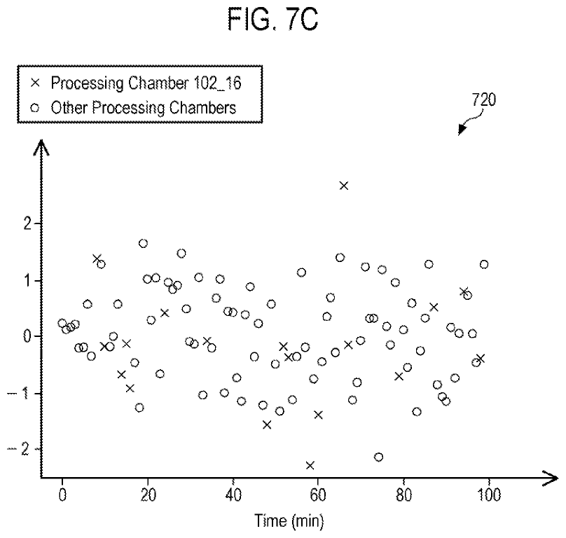

FIGS. 6 and 7A-7C show example plots of measurement data for measurement data anomaly analysis. FIG. 6 shows a graph 600 of deviations in thickness of a top layer of wafers measured by the measurement device 106_2 during a metrology inspection, when compared to a preset thickness value. The x-axis of graphs in FIGS. 6 and 7A-7C represents measurement time (in minutes (min)), and the y-axis represents difference in thickness of wafers compared to a target thickness (in nanometers (nm)). FIGS. 7A-7C show two different groups of measurement data for determining which manufacturing process and/or processing chamber may be a candidate source of anomaly in a target wafer (e.g., a wafer detected as having an anomaly by the manufacturing process controller 108A).

As an example, FIGS. 7A, 7B, and 7C correspond to manufacturing processes P4, P5, and P6 of FIG. 5 (and processing chambers 102_11, 102_14, and 102_16 of FIG. 5), respectively. For illustrative purposes, the manufacturing process P4 may be an oxidation process, the manufacturing process P5 may be a photolithography process, and the manufacturing process P6 may be an etching process. In FIGS. 7A-7C, a group of data indicated by a symbol “x” corresponds to deviation, from a preset value (e.g., a preset thickness value), in data measured for wafers (including the target wafer) that have traversed the same processing chamber as the target wafer during the corresponding manufacturing process. The group of thickness deviation data indicated by the symbol “x” is referred to as deviation of a measurement dataset of interest, while the remaining data indicated by a symbol “o” is referred to as deviation of a reference measurement dataset.

FIG. 7A illustrates an example graph 700 of deviations, from the preset value, in thickness of a top layer of wafers processed by the candidate processing chamber 102_11 and by other processing chambers of the manufacturing process P4 of FIG. 5. In FIG. 7A, data points indicated by the symbol “x” represent deviation, from a preset value, in thickness (e.g., the deviation of the measurement dataset of interest) of a top layer of wafers that have traversed the processing chamber 102_11 of the manufacturing process P4. The processing chamber 102_11 is a candidate processing chamber that the target wafer 120_2 has traversed during the oxidation process P4. The other data points indicated by the symbol “o” in FIG. 7A represent deviation, from a preset value, in thickness (e.g., the deviation of the reference measurement dataset) of a top layer of wafers that have traversed the processing chamber 102_10 or 102_12, that is, all other processing chambers of the oxidation process P4 (not including the processing chamber 102_11 traversed by the target wafer 120_2).

FIG. 7B illustrates an example graph 710 of deviations, from a preset value, in thickness of a top layer of wafers processed by a candidate processing chamber 102_14 and by the other processing chamber of the manufacturing process P5 of FIG. 5. Similar to FIG. 7A, in FIG. 7B, data points indicated by the symbol “x” represent deviation, from the preset value, in thickness (e.g., the deviation of the measurement dataset of interest) of a top layer of wafers that have traversed the processing chamber 102_14 of the manufacturing process P5. Further, the other data points indicated by the symbol “o” in FIG. 7B represent deviation, from the preset value, in thickness (e.g., the deviation of the reference measurement dataset) of a top layer of wafers that have traversed the processing chamber 102_15 of the lithography process P5.

FIG. 7C illustrates an example graph 720 of deviations, from a preset value, in thickness of a top layer of wafers processed by a candidate processing chamber 102_16 and by other processing chambers of the manufacturing process P6 of FIG. 5. Similar to FIGS. 7A and 7B, in FIG. 7C, data points indicated by the symbol “x” represent deviations, from the preset value, in thickness (e.g., the deviation of the measurement dataset of interest) of a top layer of wafers that have traversed the processing chamber 102_16 of the manufacturing process P6. Further, the other data points indicated by the symbol “o” in FIG. 7C represent deviation, from the preset value, in thickness (e.g., the deviation of the reference measurement dataset) of a top layer of wafers that have traversed the processing chamber 102_15, the processing chamber 102_17, or the processing chamber 102_19 of the etching process P6.

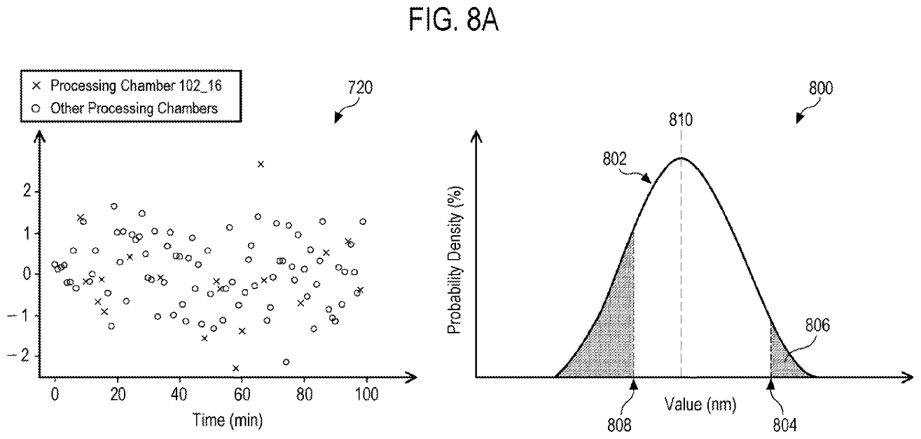

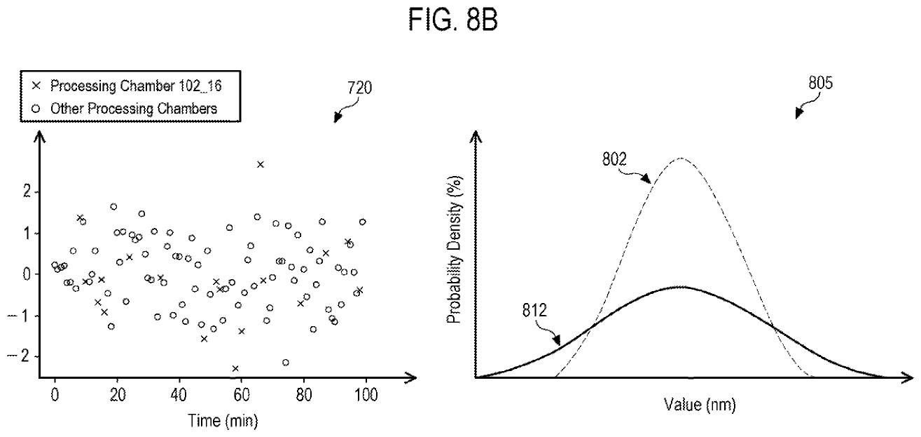

The anomaly analysis controller 108B may perform a measurement data anomaly analysis by comparing the two groups of measurement data (the measurement dataset of interest and the reference measurement dataset) against a preset value (e.g., a preset thickness value) illustrated in FIGS. 7A to 7C. As a result, a measurement data anomaly index (sometimes called a first anomaly index herein) for each of the candidate processing chambers 102_11, 102_14, and 102_16 may be determined. That is, the anomaly analysis controller 108B may perform a measurement data anomaly analysis for all manufacturing processes prior to a metrology inspection (or in between metrology inspections) to calculate measurement data anomaly indices. As an example, the measurement data anomaly analysis of measurement data shown in FIG. 7C is described herein with reference to FIG. 8A.

FIG. 8A shows the example graph 720 of FIG. 7C and an example inferred probability distribution graph 800 of measurement data of the reference measurement dataset in FIG. 7C according to one embodiment of the present disclosure. The graph 800 shows an inferred probability distribution curve 802 representing a probability density of measurement data of the reference measurement dataset of FIG. 7C. In one embodiment of the present disclosure, the anomaly analysis controller 108B may determine an inferred probability density function of the reference measurement dataset, which may be represented by a probability distribution curve 802, by fitting the measurement data of the reference measurement dataset into any suitable statistical distribution, such as a normal distribution. The x-axis of the graph 800 represents a value of measurement data, e.g., thickness in nanometers (nm), and the y-axis represents a probability density indicating a chance (%) of obtaining a measurement value of the measurement data.

Further, the anomaly analysis controller 108B may determine a value representing the measurement dataset of interest indicated by the symbol “x” in the graph 720. For example, the anomaly analysis controller 108B may calculate a mean value of the measurement dataset of interest (e.g., an average thickness of the measurement dataset of interest). In another example, the anomaly analysis controller 108B may identify a median value of the measurement dataset of interest as the representative value. The anomaly analysis controller 108B may compare the representative value and the probability distribution curve 802 of the reference measurement dataset. In one embodiment, the anomaly analysis controller 108B may determine, as a measurement data anomaly index, a degree of likelihood of the candidate processing chamber 102_16 being the source of the anomaly in the target wafer 120_2 by using the inferred probability distribution (e.g., the probability distribution curve 802) of the reference measurement dataset and the mean value of the measurement dataset of interest.

For example, a mean value of the measurement dataset of interest may be a value 804 on the x-axis of the graph 800. Based on the probability distribution curve 802 of the reference measurement dataset, the anomaly analysis controller 108B may calculate a p-value of the mean value 804 (e.g., the size of an area 806 under the probability distribution curve 802 of the reference measurement dataset). The p-value of the mean value 804 represents a probability of the physical feature or characteristic (e.g., thickness of a top layer of the corresponding wafer) being equal to or greater than the mean value 804. A measurement data anomaly index of the candidate processing chamber 102_16 may be calculated by 1-(p-value). The 1-(p-value) indicates a probability that the physical feature or characteristic (e.g., thickness of a top layer of the corresponding wafer) being smaller than the mean value 804. The higher the measurement data anomaly index of a candidate processing chamber, the higher the likelihood that the measurement data (e.g., thickness of a top layer) of the target wafer 120_2 is abnormal, that is, the higher that likelihood that corresponding candidate processing chamber contributed to the abnormality. If the mean value of the measurement dataset of interest is smaller than an average value 810 of the reference measurement dataset, for example, a value 808, the measurement data anomaly index is calculated in a similar manner by calculating a p-value of the value 808 and by calculating 1-(p-value). In some embodiments, the anomaly analysis controller 108B may output a predetermined number of measurement data anomaly indices or those exceeding a threshold value as an indication of the candidate process apparatuses being the source of the anomaly in the target product.

According to another embodiment of the present disclosure, the anomaly analysis controller 108B may determine a measurement data anomaly type in addition to a measurement data anomaly index, as part of the measurement data anomaly analysis. A measurement data anomaly type indicates a trend (e.g., upper, lower, and scattered trend) in response to a dataset of interest (e.g., measurement data of products that have been processed by a candidate processing apparatus that has been traversed by the target product). In some embodiments of the present disclosure, a measurement data anomaly type may be a combination of a scattered trend and an upper/lower trend. The anomaly analysis controller 108B may also output the measurement data anomaly type along with the measurement data anomaly index value as an indication of the candidate process apparatuses being the source of the anomaly in the target product.

The anomaly analysis controller 108B may determine a measurement data anomaly type by comparing a characteristic (e.g., mean value, variance, etc.) of a statistical distribution of the measurement dataset of interest (indicated by symbol “x” in the graph 720 of FIG. 8A) and the reference measurement dataset (indicated by symbol “o” in the graph 720 of FIG. 8A). For example, the anomaly analysis controller 108B may compare a representative value (e.g., mean value, median value, or the like) of the measurement dataset of interest against a representative value of the reference measurement dataset. As shown in the graph 800 of FIG. 8A, if the mean value of the measurement dataset of interest falls in an upper portion of the probability distribution curve 802 as indicated by the value 804 (e.g., the mean value is greater than the average 810 of the probability distribution curve 802), then the anomaly analysis controller 108B determines the measurement data anomaly type of the processing chamber 102_16 to be an upper trend. However, if the mean value of the measurement dataset of interest falls in a lower portion of the distribution curve 802 as indicated by the value 808, (e.g., the mean value is smaller than the average 810 of the probability distribution curve 802), then the anomaly analysis controller 108B determines the measurement data anomaly type to be a lower trend.

The anomaly analysis controller 108B may also compare a variance of the measurement dataset of interest and a variance of the reference measurement dataset. By comparing the variances, the anomaly analysis controller 108B may determine the measurement data anomaly type to include a scattered trend as described herein with reference to FIG. 8B. FIG. 8B shows the example graph 720 of FIG. 7C and an example inferred probability distribution graph 805 of the measurement data of the measurement dataset of interest in FIG. 7C. The graph 805 shows a probability distribution curve 812 representing the measurement data of the measurement dataset of interest in FIG. 7C. The probability distribution curve 802 of FIG. 8A is also shown as a dotted line in the graph 805.

In one embodiment of the present disclosure, the anomaly analysis controller 108B may fit the measurement data of the measurement dataset of interest into any suitable statistical distribution, such as a normal distribution. Similar to the graph 800 of FIG. 8A, the x-axis of the graph 805 represents a value of measurement data of the measurement dataset of interest, e.g. thickness in nanometers (nm), and the y-axis represents a probability density (%) of obtaining a measurement value.

In determining a measurement data anomaly type, the anomaly analysis controller 108B may compare the two datasets (e.g., the measurement dataset of interest and the reference measurement dataset) using the probability distribution curves 802 and 812. For example, the anomaly analysis controller 108 may compare a variance of the probability distribution curve 802 and a variance of the probability distribution curve 812. If the variance of the probability distribution curve 812 of the measurement dataset of interest is greater than the variance of the probability distribution curves 802 of the reference measurement dataset by a predetermined amount, then the anomaly analysis controller 108 may determine that the measurement data anomaly type is a scattered trend. In other words, if it is determined that the measurement dataset of interest is more widely distributed than the reference measurement dataset, the anomaly analysis controller 108 may determine that the measurement dataset of interest is scattered.

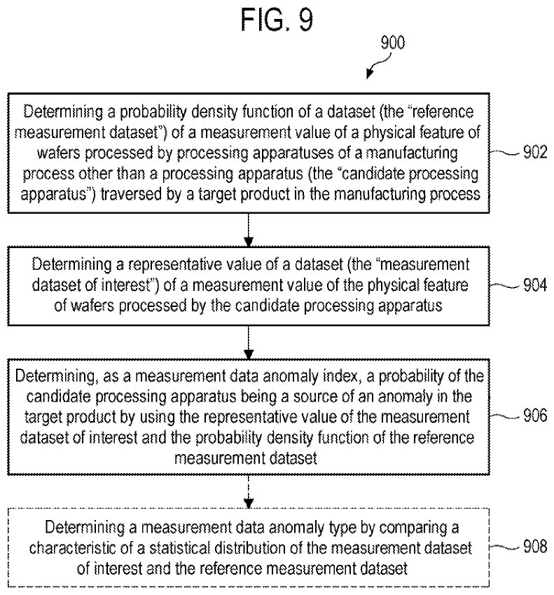

FIG. 9 shows a flowchart of a method 900 of performing a measurement data anomaly analysis performed by the anomaly analysis controller 108B for a processing apparatus (e.g., a candidate processing apparatus) traversed by a target product according to an embodiment of the present disclosure. The method of performing measurement data anomaly analysis 900 may be repeated for each physical feature or characteristic of a product measured for a candidate processing apparatus. Further, the method 900 may be repeated for each candidate processing apparatus. The anomaly analysis controller 108B may compare the measurement data anomaly indices, determine an index with the highest value, and output the highest anomaly index as an indication of the corresponding candidate processing apparatus as a source of anomaly. In some embodiments, a predetermined number of measurement data anomaly indices having the highest values or exceeding a threshold value may be output to indicate degrees of likelihood of the corresponding candidate processing apparatuses being the source of the anomaly in the target product.

At 902 of the method 900, the anomaly analysis controller 108B determines a probability density function of a dataset (e.g., the reference measurement dataset) of measurement values of a physical feature of wafers processed by processing apparatuses of a manufacturing process other than a processing apparatus (e.g., the candidate processing apparatus) traversed by a target product in the manufacturing process.

At 904, the anomaly analysis controller 108B determines a representative value of a dataset (e.g., the measurement dataset of interest) of measurement values of the physical feature of wafers processed by the candidate processing apparatus. The representative value may be a mean or median value of the measurement dataset of interest.

At 906, the anomaly analysis controller 108B determines, as a measurement data anomaly index, a degree of likelihood of the candidate processing apparatus being a source of an anomaly in the target product by using the representative value of the measurement dataset of interest and the probability density function of the reference measurement dataset. For example, the anomaly analysis controller 108B may determine a p-value of the representative value of the measurement dataset of interest using the probability density function of the reference measurement dataset. The anomaly analysis controller 108B may determine the degree of likelihood of the candidate processing apparatus being a source of an anomaly in the target product by calculating 1−(p-value).

In one embodiment, the anomaly analysis controller 108B may additionally determine a measurement data anomaly type as part of the measurement data anomaly analysis. At 908, the anomaly analysis controller 108B may determine a measurement data anomaly type by comparing a characteristic of a statistical distribution of the measurement dataset of interest and the reference measurement dataset. For example, the anomaly analysis controller 108B may compare a mean value of the measurement dataset of interest and the reference measurement dataset. If the mean value of the measurement dataset of interest is greater than the mean value of the reference measurement dataset, the anomaly analysis controller 108B may determine that the measurement data anomaly type is an upper trend. On the other hand, if the mean value of the measurement dataset of interest is smaller than the mean value of the reference measurement dataset, the anomaly analysis controller 108B may determine that the measurement data anomaly type is a lower trend. In another example, the anomaly analysis controller 108B may compare a variance of the measurement dataset of interest and a variance of the reference measurement dataset. If the variance of the measurement dataset of interest is greater than the variance of the reference measurement dataset by a preset threshold amount, the anomaly analysis controller 108B may determine that the measurement data anomaly type is a scattered trend.

### Sensor Data Anomaly Analysis

In the sensor data anomaly analysis, a sensor data anomaly index (e.g., a second index) is determined. A sensor data anomaly index is an index representing a degree of likelihood of a processing apparatus being a source of an anomaly in a target product based on sensor data of a process parameter for a manufacturing process performed by the processing apparatus. A sensor data anomaly index exceeding a threshold value or a predetermined number of top sensor data anomaly indices may be output as an indication of a processing apparatus being a source of the anomaly. The method for calculating a sensor data anomaly index for each processing apparatus in a traversal path (e.g., a path or route history) of a target product is described herein in detail with reference to FIGS. 10 and 11.

FIG. 10 shows an example graph 1000 of sensor data of the processing chamber 102_16 and an example inferred probability distribution graph 1002 of a set of sensor data (e.g., a reference sensor dataset) for the processing chamber 102_16 obtained from performing the manufacturing process P6 on wafers that have been processed before the target wafer 120_2 by the processing chamber 102_16. The graph 1000 shows temperature detected by the sensors 114_16 of the processing chamber 102_16 while performing the manufacturing process P6. The x-axis of the graph 1000 represents detected time (in minutes (min)) and the y-axis represents temperature (° C.). A data point indicated by the symbol “x” represents a temperature detected by the sensors 114_16 when the manufacturing process P6 was performed on the target wafer 120_2. Data points indicated by the symbol “o” represent temperatures detected by the sensors 114_16 when the manufacturing process P6 was performed on wafers before the target wafer 120_2 was processed.

The graph 1002 shows a probability distribution curve 1004 representing a probability density of sensor data of the reference sensor dataset of the graph 1000. In one embodiment of the present disclosure, the anomaly analysis controller 108B may determine a probability density function of the reference sensor dataset, which may be represented by a probability distribution curve 1004, by fitting the measurement data of the reference measurement dataset into any suitable statistical distribution, such as a normal distribution. The x-axis of the graph 1002 represents a value of sensor data, e.g., temperature (C), and the y-axis represents a probability density indicating a probability (%) of detecting a value of the sensor data.

The anomaly analysis controller 108B may determine sensor data of the target wafer 120_2. In this example, the sensor data of the target wafer 120_2 (e.g., a sensor dataset of interest) is a temperature of the processing chamber 102_16 when performing the manufacturing process P6 on the target wafer 120_2. The anomaly analysis controller 108B may compare the sensor data of the target wafer 120_2 and the probability distribution curve 1004 of the reference sensor dataset. In one embodiment, the anomaly analysis controller 108B may determine, as a sensor data anomaly index, a degree of likelihood of the candidate processing chamber 102_16 being the source of the anomaly in the target wafer 120_2 by using the inferred probability distribution (e.g., the probability distribution curve 1004) of the reference sensor dataset and the sensor data of the target wafer 120_2.

For example, the sensor data of the target wafer 120_2 may be a temperature 1006 on the x-axis of the graph 1002. Based on the probability distribution curve 1004 (or the probability distribution function) of the reference sensor dataset, the anomaly analysis controller 108B may calculate a p-value of the temperature 1006 (e.g., the size of an area 1008 under the probability distribution curve 1004 of the reference sensor dataset). The p-value of the temperature 1006 represents a probability of the process parameter (e.g., temperature of the processing chamber 102_16 associated with the manufacturing process P6) being greater than or equal to the temperature 1006.

Further, a sensor data anomaly index of the candidate processing chamber 102_16 may be calculated by 1-(p-value). The 1-(p-value) indicates a probability of the process parameter (e.g., temperature of the processing chamber 102_16 associated with the manufacturing process P6) being smaller than the temperature 1006. The higher the sensor data anomaly index of a candidate processing chamber, the higher the likelihood that the sensor data (e.g., temperature associated with the manufacturing process P6) of the target wafer 120_2 is abnormal, that is, the higher the likelihood that the corresponding candidate processing chamber contributed to the abnormality in the target wafer 120_2. In one embodiment, the anomaly analysis controller 108B may output a predetermined number of sensor data anomaly indices or those exceeding a threshold value as an indication of the candidate process apparatuses being the source of the anomaly in the target product.

FIG. 11 shows a flowchart of a method 1100 for performing a sensor data anomaly analysis by the anomaly analysis controller 108B for a processing apparatus (e.g., a candidate processing apparatus) traversed by a target product. The anomaly analysis controller 108B may determine a sensor data anomaly index in a similar manner as in the method of determining the measurement data anomaly index shown in FIG. 9. In the sensor data anomaly analysis, the anomaly analysis controller 108B may compare sensor data of a target product with a reference sensor dataset. The method of performing sensor data anomaly analysis 1100 may be repeated for each type of process parameters detected by sensors of a candidate processing apparatus. Further, the method 1100 may be repeated for each candidate processing apparatus. The anomaly analysis controller 108B may compare the sensor data anomaly indices, determine an index with the highest value, and output the highest anomaly index as an indication of the corresponding candidate processing apparatus as a source of anomaly. In some embodiments, a predetermined number of sensor data anomaly indices having the highest values or exceeding a threshold value may be output to indicate degrees of likelihood of the corresponding candidate processing apparatuses being the source of the anomaly in the target product.

At 1102 in the method 1100, the anomaly analysis controller 108B determines a probability density function of a dataset (e.g., the reference sensor dataset) of sensor data for a processing apparatus (e.g., a candidate processing apparatus) that has been traversed by a target product obtained from performing the corresponding manufacturing process on products that have been processed before the target product by the candidate processing apparatus. At 1104, the anomaly analysis controller 108B determines sensor data for the candidate processing apparatus obtained from performing the corresponding manufacturing process on the target product.

At 1106, the anomaly analysis controller 108B determines, as a sensor data anomaly index, a degree of likelihood of the candidate processing apparatus being a source of an anomaly in the target product based on the sensor data of the target product and the probability density function of the reference sensor dataset. For example, the anomaly analysis controller 108B may determine a p-value of the sensor data of the target product using the probability density function of the reference sensor dataset. Further, the anomaly analysis controller 108B may determine the degree of likelihood of the candidate processing apparatus being a source of an anomaly in the target product by calculating 1−(p-value).

### User Interface

FIG. 12 shows an example user interface 1200 that displays an indication of a candidate processing chamber which has performed a manufacturing process as a source of an anomaly in a target wafer based on a measurement data anomaly index and a sensor data anomaly index according to an embodiment of the present disclosure. The user interface 1200 may be displayed on a display device and includes various portions for outputting anomaly information of a candidate processing chamber for an etching process. The candidate processing chamber may be the processing chamber determined to have the highest measurement data anomaly index or the highest sensor data anomaly index among the candidate processing chambers. The user interface 1200 may include a portion 1202 for anomaly detection and portions 1204 and 1206 for showing results of measurement data anomaly analysis and sensor data anomaly analysis, respectively. In some embodiments of the present disclosure, the user interface 1200 may additionally include a portion 1208 for an image anomaly analysis and a portion 1210 for history anomaly analysis.

The top portion 1202 of the user interface 1200 may include basic information related detection (e.g., an SPC alarm) of an anomaly in a target wafer. For example, a time point when an SPC alarm is generated may be shown in the portion 1202. Further, other information such as an identifier of the candidate processing chamber, an identifier of the target wafer, an indication of an SPC rule that triggered the SPC alarm may be provided and displayed in the portion 1202.

The measurement data anomaly portion 1204 may include an example graph showing data points of thickness of wafers processed by the candidate processing chamber and other processing chambers that performed an etching process. In the graph, the dataset of interest is indicated by an “x” symbol, the reference dataset is indicated by an “o” symbol, and the target wafer (or the alarmed wafer) is indicated by a star symbol. The graph may include lines indicating upper and lower control limits (UCL and LCL) and placed at a certain distance from a target value, which is the preset thickness value. The measurement data anomaly portion 1204 may also include a measurement data anomaly index and a measurement data anomaly type.

The sensor data anomaly portion 1206 may include an example graph showing sensor data for the candidate chamber obtained from performing the corresponding manufacturing process on the target wafer and wafers that have been processed before the target wafer by the candidate processing chamber. For example, the graph of the sensor data anomaly portion 1206 shows data points of temperatures detected by a sensor of the candidate processing chamber when performing an etching process. Specifically, the temperature for the target wafer (or the alarmed wafer) is indicated by a star symbol while the other temperature data points are indicated by the symbol “o”. The graph of the sensor data anomaly portion 1206 may further show lines indicating upper and lower control limits (UCL/LCL) and a target temperature. The sensor data anomaly portion 1206 may also include a sensor data anomaly index.

The user interface 1200 may also include other portions to provide additional information for better understanding of the anomaly detection and determination of a source of the anomaly to facilitate appropriate remedial actions by engineers. In some embodiments of the present disclosure, the user interface 1200 may additionally include an image anomaly portion 1208. The image anomaly portion 1208 may include an image of dies in the alarmed wafer and indicate an abnormal image. For example, an image which includes a blurred or misaligned portion may be determined to be an abnormal image. Such an abnormal image may be indicated in the image anomaly portion 1208.

The user interface 1200 may also include a history anomaly portion 1210. In the history anomaly portion 1210, a record of events such as a repair, suspension of operation, and cleaning of candidate processing chambers from event logs may be included. The history of the candidate processing chambers may be categorized by a process name, lot history and/or apparatus history.

In some embodiments, methods disclose herein may further comprise: generating a first route history of the target product along the candidate processing apparatuses: generating a second route history of a reference product along the candidate processing apparatuses; and calculating a route history index associated with the first route history and the second route history, wherein the route history index is indicative of a likelihood of the first route history being associated with the source of the anomaly. For example, the reference product may be processed along the same path of candidate processing apparatuses as the target product but at a different time. Measurements may be performed on the reference product, e.g., measurement of a critical dimension. Measurements of the target product may be statistically compared to measurements of the reference product to determine a route history index. The route history index may provide another likelihood that the first route history associated with the candidate processing apparatuses is likely the source of the anomaly. In some cases, the route history index can be statistically analyzed in conjunction with the first index (associated with the measurement data) and/or the second index (associated with the sensor data) to generate a composite anomaly score, which can increase the likelihood of determining the source of the anomaly. In some cases, the user interface 1200 may output an indication of the first route history, the second route history, the route history index, or the composite anomaly score.

### Machine Learning Methods

According to another aspect of the present disclosure, there is provided a method for determining a source of an anomaly in a manufacturing process, comprising: (i) obtaining an anomaly score for each of the processing apparatuses: (ii) applying a trained machine learning model to each anomaly score to determine that at least one anomaly score is indicative of a processing apparatus being the source of the anomaly; and (iii) generating, based at least on the one anomaly score, one or more recommendations to correct the source of the anomaly.

Many machine learning methods implemented as algorithms are suitable as approaches to perform the methods described herein. Such methods include but are not limited to supervised learning approaches, unsupervised learning approaches, semi-supervised approaches, or any combination thereof.

Machine learning algorithms may include, without limitation, neural networks (e.g., artificial neural networks (ANN), multi-layer perceptrons (MLP)), support vector machines, k-nearest neighbors, Gaussian mixture model, Gaussian, naive Bayes, decision trees, or radial basis functions (RBF). Linear machine learning algorithms may include without limitation linear regression, logistic regression, naive Bayes classifier, perceptron, or support vector machines (SVMs). Other machine learning algorithms for use with methods according to the disclosure may include without limitation quadratic classifiers, k-nearest neighbor, boosting, decision trees, random forests, neural networks, pattern recognition, Bayesian networks, or Hidden Markov models. Other machine learning algorithms, including improvements or combinations of any of these, commonly used for machine learning, can also be suitable for use with the methods described herein. Any use of a machine learning algorithm in a workflow can also be suitable for use with the methods described herein. The workflow can include, for example, training, testing, validation, cross-validation, nested-cross-validation, feature selection, row compression, data transformation, binning, normalization, standardization, or algorithm selection.

In some embodiments, the machine learning model is obtained by: training the model using (1) a first and second subset of the sensor data, (2) a first and second subset of the measurement data, and (3) associating an anomaly score with each of the first and second subsets of the sensor data and/or the measurement data: validating the model on an independent subset of the sensor data and/or the measurement data associated with the processing apparatuses that have been determined to be sources of past anomalies; and selecting a threshold performance for the validated model such that the validated model determines the source of the anomaly within the threshold performance, wherein the threshold performance is associated with a mean squared error (MSE), a root mean squared error (RMSE), and/or a mean absolute error (MAE).

A machine learning algorithm can generally be trained by the following methodology to build a machine learning model.

1. Gather a dataset for “training” and “testing” the machine learning algorithm. The dataset can include many features, for example, features associated with measurement data or sensor data. The training dataset is used to “train” the machine learning algorithm. The testing dataset is used to “test” the machine learning algorithm. In some cases, the datasets may be calibrated by removing biases associated with determinations of dataset integrity, e.g., biases associated with human determinations of dataset integrity. In some cases, the datasets may include labeling of datasets for training and testing, e.g., labeling by humans such as field engineers assessing whether data in a dataset is associated with a measurement anomaly or a source anomaly.

2. Determine “features” for the machine learning algorithm to use for training and testing. The accuracy of the machine learning algorithm may depend on how the features are represented. For example, feature values may be transformed using one-hot encoding, binning, standardization, or normalization. Also, not all features in the dataset may be used to train and test the machine learning algorithm. Selection of features may depend on, for example, available computing resources and time or importance of features discovered during iterative testing and training. In some cases, features may be associated with p-values described elsewhere herein.

3. Choose an appropriate machine learning algorithm. For example, a machine learning algorithm described elsewhere herein may be chosen. The chosen machine learning algorithm may depend on, for example, available computing resources and time or whether the prediction is continuous or categorical in nature. The machine learning algorithm is used to build the machine learning model.

4. Build the machine learning model. The machine learning algorithm is run on the gathered training dataset. Parameters (e.g., hyperparameters) of the machine learning algorithm may be adjusted by optimizing performance on the testing dataset or via cross-validation (e.g., nested cross-validation) datasets. After parameter adjustment and learning, the performance of the machine learning algorithm may be validated on a dataset of naive samples (e.g., data that has not been labelled or used during training or testing) that are separate from the training dataset and testing dataset. The built machine learning model can involve feature coefficients, importance measures, or weightings assigned to individual features.

Once the machine learning model is determined as described above (“trained”), it can be used to determine a source of an anomaly in a manufacturing process.

While preferred embodiments of the present disclosure have been shown and described herein, such embodiments are provided by way of example only. It is not intended that the present disclosure be limited by the specific examples provided within the specification. While the present disclosure has been described with reference to the aforementioned specification, the descriptions and illustrations of the embodiments herein are not meant to be construed in a limiting sense. Numerous variations, changes, and substitutions may occur without departing from the present disclosure. Furthermore, it shall be understood that all aspects of the present disclosure are not limited to the specific depictions, configurations or relative proportions set forth herein which depend upon a variety of conditions and variables. It should be understood that various alternatives to the embodiments of the present disclosure described herein may be employed in practicing the present disclosure. It is therefore contemplated that the present disclosure shall also cover any such alternatives, modifications, variations, or equivalents. It is intended that the following claims define the scope of the present disclosure and that methods and structures within the scope of these claims and their equivalents be covered thereby.

1. A method for determining a source of an anomaly in a manufacturing process, comprising:
(a) receiving sensor data of one or more process parameters associated with processing apparatuses for carrying out the manufacturing process;
(b) receiving measurement data of one or more predetermined features associated with products of the manufacturing process; and
(c) determining, based at least on the one or more process parameters and/or the one or more predetermined features, an anomaly index indicative of a likelihood of a candidate processing apparatus being the source of the anomaly.

2. The method of claim 1, wherein the manufacturing process comprises one or more manufacturing processes sequentially performed by one or more sets of processing apparatuses, respectively, one manufacturing process being performed by one set of processing apparatuses independently.

3. The method of claim 2, wherein the sensor data is detected by sensors of each of the processing apparatuses that have performed corresponding manufacturing processes on a plurality of products.

4. The method of claim 2, wherein the measurement data comprises one or more predetermined features of each of the products after the one or more manufacturing processes have been performed on each of the products.

5. The method of claim 4, further comprising between (b) and (c), upon detection of the anomaly in a target product among the products based on the measurement data, identifying one or more processing apparatuses among the processing apparatuses that have been traversed by the target product as candidate processing apparatuses.

6. The method of claim 5, further comprising between (b) and (c), determining, for each candidate processing apparatus, at least one first index indicating at least one first degree of likelihood of the candidate processing apparatus being the source of the anomaly in the target product based on the measurement data obtained for a subset of one or more products among a set of products that have traversed the candidate processing apparatus and a first reference set of the measurement data obtained for the remaining products among the set of products.

7. The method of claim 3, further comprising between (b) and (c), determining, for each candidate processing apparatus, at least one second index indicating at least one second degree of likelihood of the candidate processing apparatus being the source of the anomaly in a target product based on the sensor data for the candidate processing apparatus obtained from performing the corresponding manufacturing process on the target product and a second reference set of the sensor data for the candidate processing apparatus obtained from performing the corresponding manufacturing process on one or more products among the plurality of products that have been processed before the target product by the candidate processing apparatus.

8. The method of claim 6 or 7, further comprising after (c), outputting an indication of one or more candidate processing apparatuses as the source of the anomaly in the target product based at least on the anomaly index, wherein the anomaly index comprises the at least one first index and/or the at least one second index.

9. The method of claim 8, wherein determining the at least one first index indicating the at least one first degree of likelihood comprises comparing the measurement data obtained for the subset of one or more products among the set of products that have traversed the candidate processing apparatus and the first reference set of the measurement data obtained for the remaining products among the set of products, and
wherein determining the at least one second index indicating the at least one second degree of likelihood comprises comparing the sensor data for the candidate processing apparatus obtained from performing the corresponding manufacturing process on the target product and the second reference set of the sensor data.

10. The method of claim 9, wherein the second reference set of the sensor data includes the process parameters of each of the products other than the target product on which the candidate processing apparatus has performed the corresponding manufacturing process.

11. The method of claim 1, wherein the manufacturing process comprises one or more semiconductor manufacturing processes, wherein the processing apparatuses comprise one or more processing chambers, and wherein the products comprise one or more semiconductor wafers.

12. The method of claim 1, wherein the one or more process parameters include at least one of a temperature, a pressure, power, or a flow rate, and wherein the one or more predetermined features include at least one of a depth, a thickness, length, or a radius of a product.

13. The method of claim 9, wherein the one or more process parameters include a plurality of process parameters, and the one or more predetermined features include a plurality of predetermined features,
wherein determining the at least one second index indicating the at least one second degree of likelihood comprises determining a plurality of second indices respectively indicating the second degrees of likelihood of the candidate processing apparatus being the source of the anomaly in the target product, and
wherein determining the at least one first index indicating the at least one first degree of likelihood comprises determining a plurality of first indices respectively indicating the first degrees of likelihood of the candidate processing apparatus being the source of the anomaly in the target product.

14. The method of claim 9, wherein determining the at least one first index comprises:
determining a probability density function of the first reference set of the measurement data obtained for the remaining products among the set of products;
determining a representative value of the measurement data obtained for the subset of one or more products among the set of products that have traversed the candidate processing apparatus; and
determining the at least one first degree of likelihood of the candidate processing apparatus being the source of the anomaly in the target product based on the representative value and the probability density function of the first reference set.

15. The method of claim 9, wherein determining the at least one second index comprises:
determining a probability density function of the second reference set of the sensor data for the candidate processing apparatus obtained from performing the corresponding manufacturing process on the one or more products among the plurality of products that have been processed before the target product by the candidate processing apparatus;
acquiring the sensor data for the candidate processing apparatus obtained from performing the corresponding manufacturing process on the target product; and
determining the at least one second degree of likelihood of the candidate processing apparatus being the source of the anomaly in the target product based on the sensor data for the candidate processing apparatus and the probability density function of the second reference set.

16. The method of claim 13, wherein outputting the indication of the one or more candidate processing apparatuses as the source of the anomaly in the target product comprises:
outputting one or more first indices of a selected candidate processing apparatus among the one or more candidate processing apparatuses;
outputting a first graph showing the measurement data obtained for the subset of one or more products among the set of products that have traversed the selected candidate processing apparatus and the first reference set of the measurement data obtained for the remaining products among the set of products;
outputting one or more second indices of the selected candidate processing apparatus; and
outputting a second graph showing the sensor data for the selected candidate processing apparatus obtained from performing the corresponding manufacturing process on the target product and the second reference set of the sensor data for the selected candidate processing apparatus obtained from performing the corresponding manufacturing process on the one or more products among the plurality of products that have been processed before the target product by the selected candidate processing apparatus.

17. The method of claim 1, wherein the determining in (c) comprises:
(i) obtaining an anomaly score for each of the processing apparatuses;
(ii) applying a trained machine learning model to each anomaly score to determine that at least one anomaly score is indicative of a processing apparatus being the source of the anomaly; and
(iii) generating, based at least on the one anomaly score, one or more recommendations to correct the source of the anomaly.

18. The method of claim 17, wherein the trained machine learning model is obtained by:
training the model using (1) a first and second subset of the sensor data, (2) a first and second subset of the measurement data, and (3) associating an anomaly score with each of the first and second subsets of the sensor data and/or the measurement data;
validating the model on an independent subset of the sensor data and/or the measurement data associated with the processing apparatuses that have been determined to be sources of past anomalies; and
selecting a threshold performance for the validated model such that the validated model determines the source of the anomaly within the threshold performance, wherein the threshold performance is associated with a mean squared error (MSE), a root mean squared error (RMSE), and/or a mean absolute error (MAE).

19.-33. (canceled)
